(19) United States
(12) Patent Application Publication
(10) Pub. No.: US 2026/0230123 A1
(43) Pub. Date: Aug. 6, 2026

(54) Methods and Apparatus for Enabling Selection of UE Receiver Capability

(71) Applicant: Telefonaktiebolaget LM Ericsson (publ), Stockholm (SE)

(72) Inventors: Kazuyoshi Uesaka, Kawasaki, Kanagawa (JP); Muhammad Alli Kazmi, Sundbyberg (SE); Jiakai Shi, Beijing (CN)

(21) Appl. No.: 19/154,870

(22) PCT Filed: Feb. 2, 2024
(86) PCT No.: PCT/SE2024/050096

§ 371 Date: Aug. 8, 2025

(30) Foreign Application Priority Data
Feb. 10, 2023 (WO) PCT/CN2023/075499

(51) Int. Cl. H04B 7/0452

(52) U.S. Cl. CPC H04B 7/0452

(57) ABSTRACT

Methods and apparatus for determining or selecting among UE receiver capabilities for MIMO data transmission are provided A method (300) in a UE (100) may include transmitting (S302), to a network node (200) connected to the UE (100), UE receiver capability information indicating an MU-MIMO receiver capability supported by the UE (100), wherein the MU-MIMO receiver capability includes at least one advanced MU-MIMO receiver capability; reporting (S304), to the network node, UE Assistance Information, UAI, indicating the UE's preference on an MU-MIMO receiver capability; receiving (S306), from the network node, Network Assistance Information, NAI, that is determined by the network node based on the UE receiver capability information and the reported UAI; and receiving (S308) data from the network node by using an MU-MIMO receiver capability based on the received NAI.

### TECHNICAL FIELD

The present disclosure relates generally to the field of communication networks, and more specifically to techniques for enabling determination or selection of UE receiver capabilities for MIMO data transmission.

### BACKGROUND

Multiple-Input Multiple-Output (MIMO) transmission is a signal transmission scheme using multiple antenna elements at the transmitter and multiple antenna elements at the receiver. The benefit or gain of MIMO transmission is summarized as follows:
receiver diversity gain: reducing the impact of fading when the fades on each propagation path are uncorrelated.
beamforming gain: directing the transmit signal towards to the target UE with the multiple transmit antennas. This will improve the received signal to noise ratio (SNR).
spatial multiplexing gain: transferring multiple streams (layers) of data simultaneously using the same set of time and frequency domain resources. It is also called multi-stream transmission or multi-layer transmission. This scheme will increase the data throughput.

MIMO with the spatial multiplexing method can be categorized further as Single-user MIMO (SU-MIMO) and Multi-user MIMO (MU-MIMO) according to the number of the target UEs.

When all the data streams are transmitted to one UE, it is called SU-MIMO, as shown in FIG. 1. In this example, the network (NW) node transmits signals with 2 data layers (streams) from Tx ports (or transmission point) 1 and 2 to a single UE (i.e., UE1).

Assume the UE has two receive antennas, at the UE receive antenna, the received signals are modelled as the following formula:

$$[ \begin{matrix}{y}_{1}^{UE 1} \\ {y}_{2}^{UE 1}\end{matrix} ] = [ \begin{matrix}{h}_{11} & {h}_{12} \\ {h}_{21} & {h}_{22}\end{matrix} ] [ \begin{matrix}{d}_{1} \\ {d}_{2}\end{matrix} ] + [ \begin{matrix}{n}_{1}^{UE 1} \\ {n}_{2}^{UE 1}\end{matrix} ]$$

$$where {y}_{a}^{UE 1}$$

is the received signal at UE1 receive antenna a, hₐₓ is the propagation channel coefficients from the NW node antenna port x to UE receive antenna a, and

$${n}_{a}^{UE 1}$$

is the additional white Gaussian noise (AWGN) at UE1 receive antenna a, dx is the transmit data at data steam x transmitted from the NW node antenna port x. When the NW node applies SU-MIMO, the NW node usually applies the precoding weight to the transmit signals to mitigate the interference between data steams (inter-stream interference), as follows:

$$[ \begin{matrix}{y}_{1}^{U E 1} \\ {y}_{2}^{U E 1}\end{matrix} ] = [ \begin{matrix}{h}_{11} & {h}_{12} \\ {h}_{21} & {h}_{22}\end{matrix} ] [ \begin{matrix}{b}_{11} & {b}_{12} \\ {b}_{21} & {b}_{22}\end{matrix} ] [ \begin{matrix}{d}_{1} \\ {d}_{2}\end{matrix} ] + [ \begin{matrix}{n}_{1}^{U E 1} \\ {n}_{2}^{U E 1}\end{matrix} ]$$

where bᵢⱼ is precoding weights to mitigate the inter-steam interference during the propagation channel from the NW transmit antenna to UE receive antennas. In order to derive the precoding weights, for example, the NW node requests UE to report the preferred precoding weights (or precoding matrix indicator (PMI)) using the CSI reporting framework, especially in the FDD bands where the uplink and downlink signals are transmitted in different carrier frequencies. As another example, in the case of TDD bands where both uplink and downlink signals are transmitted in the same carrier frequency, the NW node can acquire the propagation channel coefficients from the uplink signal measurement, and they can derive the precoding weights without asking UE to report PMI.

On the other hand, if the data streams are transmitted to multiples UEs simultaneously, e.g., one data stream to UE1 and another data stream to UE2, it is called MU-MIMO, as shown in FIG. 2. In this example, the NW node transmits one data stream to UE1 using the Tx antenna port 1 and transmit another data stream to UE2 using the Tx antenna port 2.

Assume each UE has one receive antenna, at the UE receive antenna, the received signals are modelled by the following formula:

$$[ \text{} \begin{matrix}{y}_{1}^{U E 1} \\ {y}_{2}^{U E 1} \\ {y}_{2}^{UE 2} \\ {y}_{2}^{UE 2}\end{matrix} ] = [ \text{} \begin{matrix}{h}_{11}^{UE 1} & {h}_{12}^{UE 1} \\ {h}_{21}^{UE 1} & {h}_{22}^{UE 1} \\ {h}_{11}^{UE 2} & {h}_{12}^{UE 2} \\ {h}_{21}^{UE 2} & {h}_{22}^{UE 2}\end{matrix} ] [ \text{} \begin{matrix}{b}_{11} & {b}_{12} & {b}_{13} & {b}_{14} \\ {b}_{21} & {b}_{22} & {b}_{23} & {b}_{24}\end{matrix} ] [ \text{} \begin{matrix}{d}_{UE 1}^{( 1 )} \\ {d}_{UE 2}^{( 1 )}\end{matrix} ] + [ \text{} \begin{matrix}{n}_{1}^{U E 1} \\ {n}_{2}^{U E 1} \\ {n}_{1}^{UE 2} \\ {n}_{2}^{UE 2}\end{matrix} ] where {y}_{a}^{UEn}$$

is the received signal at UE n receive antenna a,

$${h}_{a x}^{UEn}$$

is the propagation channel coefficients from the NW node antenna port x to UE n receive antenna a, and

$${n}_{a}^{UEn}$$

is the AWGN at UE n receive antenna a,

$${d}_{UEn}^{( x )}$$

is the transmit data at data steam x to UE n. When the NW node applies MU-MIMO, as same as SU-MIMO, the NW node usually applies the precoding weight, bᵢⱼ, to the transmitted signals to mitigate the interference between user data steams (intra-cell inter-user interference).

Hereafter, an introduction of MIMO transmission schemes in 3GPP NR will be provided.

3GPP NR supports both SU-MIMO and MU-MIMO. When the NW node transmits data signal using the MIMO multi-stream transmission, the NW node configures the UEs which Tx port is used to transmit the data stream x. In 3GPP NR, it is called demodulation reference signal port (DMRS port). The total number of configured DMRS ports corresponds to the maximum number of MIMO streams (layers) the NW node will schedule to the UE. According to 3GPP TS 38.211 [1], the NW node supports up to 8-layer transmission for SU-MIMO (i.e., 8 DMRS ports) and up to 12-layer transmission for MU-MIMO.

When the NW node configures the DMRS ports, e.g., DMRS ports 0 and 1, the configured UE should receive the demodulation reference signals (DMRS) corresponding to DMRS ports 0 and 1, and demodulate the data signal (e.g., PDSCH) using the channel estimates derived from the DMRS sequence. 3GPP TS38.211 [1] specifies DMRS sequence generation method per DMRS port number (See 3GPP TS 38.211 [1], clause 7.4.1.1 for the sequence generation). The key parameters to differentiate the DMRS sequences each other is:
DMRS port number
Scrambling ID0
Scrambling ID1
n_SCID
Cell ID

Scrambling ID0 and ID1 are signaled via RRC layer signaling when the NW node configures the data channel (PDSCH). Cell ID is cell specific ID and it is known when UE are connected to the serving NW code at the initial cell access. The last parameter n_SCID is provided in the downlink control indicator 1_1 (DCI 1_1) via control channel (PDCCH) in the slot the NW node transmits PDSCH.

FIG. 3 illustrates an example of time and frequency resource (or OFDM symbol) mapping for NR, where the NW node configures 4 DMRS ports (0, 1, 2, 3). According to the standard, DMRS symbols for DMRS ports 0 and 1 are multiplexed on one OFDM symbol. In other words, two DMRS ports share one OFDM symbol. Similarly, DMRS symbols for DMRS ports 2 and 3 are multiplexed on one OFDM symbol.

On the other hand, all the PDSCH symbols transmitted from DMRS ports 0, 1, 2, and 3 are multiplexed to one OFDM symbol. Note OFDM symbols for PDSCH, i.e., d_{PDSCH}(k, l) are not overlapped with OFDM symbols for DMRS, i.e., d_{DMRS}(l′, k′).

According to the standard, the NW node transmits the DMRS sequence information only for the configured DMRS ports, in other words, UE does now know what DMRS ports are configured to other UEs. For example, when the NW node applies SU-MIMO and the NW node configures DMRS ports 0 and 1 to UE1, the UE1 only derives

$${d}_{UE 1}^{( 0 )} ( k , l ) and {d}_{UE 1}^{( 1 )} ( k , l ) ,$$

only from DMRS symbols for ports 0 and 1.

As another example, when the NW node applies MU-MIMO and the NW node configures DMRS ports 0 and 1 to UE1 and configures DMRS ports 2 and 3 to UE2, UE1 derives

$${d}_{UE 1}^{( 0 )} ( k , l ) and {d}_{UE 1}^{( 1 )} ( k , l )$$

only from DMRS symbols for ports 0 and 1. Similarly, UE2 derives

$${d}_{UE 2}^{( 0 )} ( k , l ) and {d}_{UE 2}^{( 1 )} ( k , l )$$

only from DMRS symbols for ports 2 and 3.

There are several UE receiver algorithms for MIMO multi-stream transmission. For a UE supporting multiple types of MIMO receiver algorithms, it would benefit the UE's operation if the UE can determine or select a suitable MIMO receiver algorithm for data reception, especially in a scenario of MU-MIMO data transmission. It also would be beneficial if the network node could know the MIMO receiver algorithm that the UE can apply currently.

### LIST OF REFERENCES

[1] 3GPP TS 38.211, “NR; Physical channels and modulation,” V17.4.0.
[2] 3GPP TS 38.101-4, “NR; User Equipment (UE) radio transmission and reception; Part 4: Performance requirements”, V17.7.0.
[3] 3GPP TR 36.829, “Enhanced performance requirement for LTE User Equipment (UE)”, V11.1.0.
[4] 3GPP TR 36.866, “Study on Network-Assisted Interference Cancellation and Suppression (NAIC) for LTE”, V12.00.1.
[5] 3GPP TS 38.331, “NR; Radio Resource Control (RRC); Protocol specification”, V17.3.0.
[6] 3GPP TS 38.306, “NR; User Equipment (UE) radio access capabilities”, V17.3.0.

### SUMMARY

In view of at least the above problems, embodiments of the present disclosure provide techniques for enabling determination or selection among UE receiver capabilities for MIMO data transmission.

In some embodiments, a method in a UE may include transmitting, to a network node connected to the UE, UE receiver capability information indicating an MU-MIMO receiver capability supported by the UE, wherein the MU-MIMO receiver capability includes at least one advanced MU-MIMO receiver capability; reporting, to the network node, UE Assistance Information, UAI, indicating the UE's preference on an MU-MIMO receiver capability; receiving, from the network node, Network Assistance Information, NAI, that is determined by the network node based on the UE receiver capability information and the reported UAI; and receiving data from the network node by using an MU-MIMO receiver capability based on the received NAI.

In some embodiments, a method in a network node may include receiving, from a UE connected to the network node, UE receiver capability information indicating an MU-MIMO receiver capability supported by the UE, wherein the MU-MIMO receiver capability includes at least one advanced MU-MIMO receiver capability; receiving, from the UE, a report of UE Assistance Information, UAI, indicating the UE's preference on an MU-MIMO receiver capability; and providing, to the UE, Network Assistance Information, NAI, wherein the NAI is based on a MIMO transmission scheme to be used, the UE receiver capability information and the UAI.

In some embodiments, a UE may include a processor and a memory storing instructions that, when executed by the processor, cause the UE to perform the above method in the UE.

In some embodiments, a network node may include a processor, and a memory storing instructions that, when executed by the processor, cause the network node to perform the above method in the network node.

In some embodiments, a computer-readable storage medium may have computer-readable instructions stored therein. The computer-readable instructions, when executed by a processor of a User Equipment (UE), may configure the UE to perform the above method in the UE, or when executed by a processor of a network node, configure the network node to perform the above method in the network node.

### BRIEF DESCRIPTION OF THE DRAWINGS

These and other objects, features, and advantages of the present disclosure will become apparent upon reading the following Detailed Description in view of the Drawings briefly described below.

FIG. 1 shows an example of SU-MIMO transmission with 2 Tx ports (2 layers).

FIG. 2 shows an example of MU-MIMO transmission to 2 UEs (one layer per UE).

FIG. 3 illustrates an example of time and frequency resource (or OFDM symbol) mapping for NR.

FIG. 4 shows a scenario in which at least two UEs are served by the serving network node in the same serving cell.

FIG. 5 shows a link simulation result of PDSCH throughput according to the parameters in Table 1.

FIG. 6 shows another link simulation result of PDSCH throughput according to the parameters in Table 2.

FIG. 7 shows UE assistance information reporting procedure.

FIG. 8 shows UE capability information reporting procedure.

FIG. 9 is a flowchart illustrating an exemplary method in a UE according to various embodiments of the present disclosure.

FIG. 10 is a flowchart illustrating an exemplary method in a network node according to various embodiments of the present disclosure.

FIG. 11 shows an exemplary flow of a procedure of determining or selecting among UE receiver capabilities for MIMO data transmission according to various embodiments of the present disclosure.

FIG. 12 shows a schematic block diagram of a UE according to some embodiments of the present disclosure.

FIG. 13 shows a schematic block diagram of a network node according to some embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in which functions implemented by some embodiments of the present disclosure may be virtualized.

FIG. 19 illustrates communication between a host computing system, a network node, and a UE via multiple connections, according to various embodiments of the present disclosure.

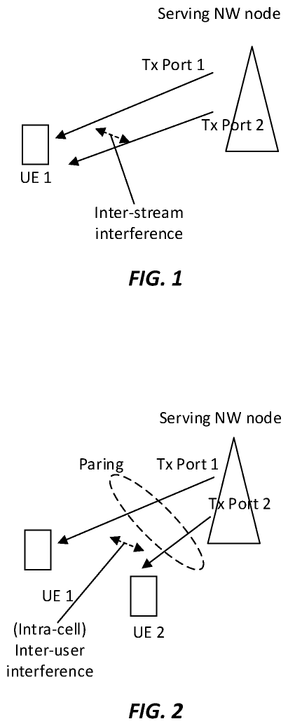

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate.

Likewise, any advantage of any of the embodiments can apply to any other embodiments, and vice versa. Other objects, features and advantages of the disclosed embodiments will be apparent from the following description.

In the present disclosure the term “node” is used which may be a network (NW) node or a user equipment (UE).

Examples of network nodes are NodeB, base station (BS), multi-standard radio (MSR) radio node such as MSR BS, eNodeB, gNodeB, MeNB, SeNB, location measurement unit 10 (LMU), integrated access backhaul (JAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Reduced Capability (RedCap) UE, PDA, tablet, mobile terminals, smart phone, laptop embedded equipment (LEE), laptop mounted equipment (LME), USB dongles, fixed wireless access (FWA) node, customer premises equipment (CPE), integrated access backhaul mobile terminal (JAB-MT), network-controlled repeater mobile terminal (NCR-MT) etc.

The term “radio access technology”, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term “signal” or “radio signal” used herein may be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH. sPUCCH. sPUSCH, MPDCCH, NPDCCH, NPDSCH, E-PDCCH, PUSCH, PUCCH, NPUSCH etc.

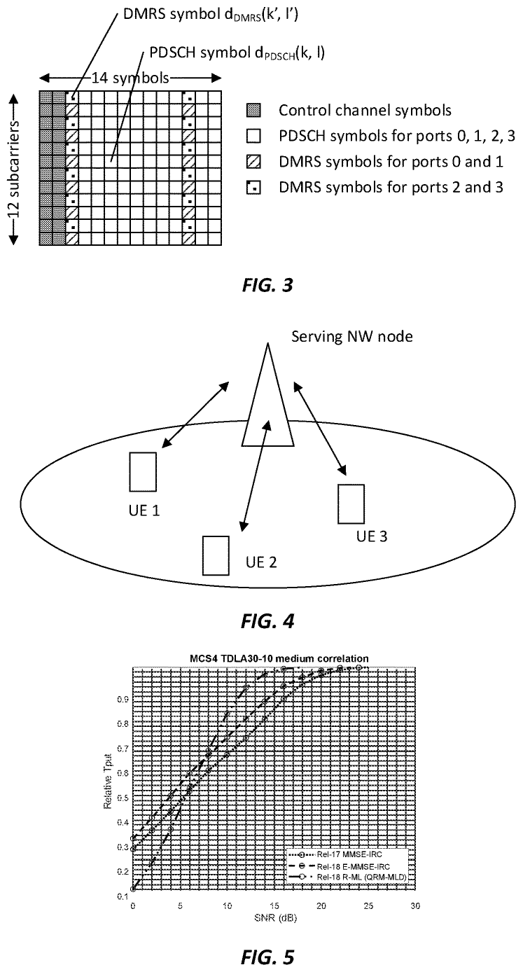

The term “receiver capability” may refer to a UE's capability of supporting one or more receiver configurations or algorithms. Herein the term may be used interexchangeably with the term “receiver algorithm” and the term “receiver configuration.” FIG. 4 shows a scenario in which at least two UEs (e.g., UE1, UE2, UE3, . . . ) are served by the serving network node (serving NW node) in the same serving cell. The serving NW node may transmit signal with one or more frequency component carriers (e.g., CC1, CC2, CC3), which can belong to the same frequency band or different frequency bands. The serving NW node may transmit signals from one or more transmission reception points (TRP).

The serving NW node may or may not have the functionality to transmit signals with MU-MIMO.

UEs served by the serving NW node may be capable of one or more advanced MU-MIMO receiver algorithms or may not be capable of any advanced MU-MIMO receiver algorithms.

The carrier frequencies on which the UE is configured to operate (e.g. receive and/or transmit) signals (e.g. RS, PDSCH, PCCH etc) may belong to certain frequency range (FR). Examples of FR are within frequency range 1 (FR1), within frequency range 2 (FR2), within frequency range 3 (FR3) etc. In one example frequencies within FR2 are frequencies above certain threshold e.g. 24 GHz or higher. In another example the frequencies in FR2 may vary between 24 GHz to 52.6 GHz. In another example frequencies in FR2 may vary between 24 GHz to 71 GHz. Frequencies in FR1 are below the frequencies in FR2. FR2 may further comprise of two or more sub frequency ranges: FR2-1, FR2-2 etc. The frequencies in FR2-1 may vary between 24 GHz to 52.6 GHz. The frequencies in FR2-2 may vary between 24 GHz to 71 GHz. In one example frequencies in FR1 range between 410 MHz and 7125 MHz.

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

There are several UE MIMO receiver algorithms published in literatures. Here, we provide three receiver algorithms of MMSE-IRC, E-MMSE-IRC, and R-ML, although the embodiments of the present disclosure are not limited thereto.

Minimum Mean Square Error Receiver with Interference Rejection Combining (MMSE-IRC) Receiver Algorithm

MMSE-IRC receiver algorithm [3] is normally used in NR UE. For example, 3GPP UE demodulation performance requirements (TS 38.101-4 [2]) are set based on MMSE-IRC receiver algorithm performance.

With the MMSE-IRC receiver algorithm, the demodulated data symbols (i.e., PDSCH data symbols) corresponding to subcarrier index k and time index l from DMRS port p are derived by

$${d}_{PDSCH}^{( p )} ( k , l ) = {w}^{( p )} ( k , l ) y ( k , l )$$

Where y(k, l) is the (Nr×1) matrix of received OFDM symbols for data channel (PDSCH), that is, y(k, l)=[y₁(k, l) y₂(k, l) . . . y_{N}r(k, l)]^{T}, where yᵢ(k, l) is the received PDSCH OFDM symbols at receive antenna i, subcarrier index k, time index 1, and Nr is the number of UE receive antennas. w^{(p)}(k, l) is the combining weights for DMRS port p given by:

$${w}^{( p )} ( k , l ) = {( {h}^{( p )} ( k , l ) )}^{H} {{R}_{M} ( k , l )}^{- 1}$$

Where h^{(p)}(k, l) is the (Nr×1) matrix of channel estimates for DMRS port p, that is,

$${h}^{( p )} ( k , l ) = {[ \begin{matrix}{h}_{1}^{( p )} ( k , l ) & {h}_{2}^{( p )} ( k , l ) & … & {h}_{Na}^{( p )} ( k , l )\end{matrix} ]}^{T} ,$$

$$where$$

$${h}_{i}^{( p )} ( k , l )$$

is the channel estimates from DMRS port p at receive antenna i, and Nr is the number of UE receive antennas. A^{H} means Hermitian transportation of matrix A.

R_{M}(k, l) is (Nr×Nr) noise covariance matrix for MMSE-IRC given by:

$${R}_{M} ( k , l ) = h ( k , l ) {h}^{H} ( k , l ) + \frac{1}{{N}_{DMRS}} {\sum }_{( {k}^{′} , {l}^{′} ) ∈ DMRS} \tilde{r} ( {k}^{′} , {l}^{′} ) {\tilde{r}}^{H} ( {k}^{′} , {l}^{′} )$$

Where N_{DMRS} is the number of DMRS symbols to calculate the noise covariance matrix, and h(k, l) is (Nr×Np) matrix of channel estimates given by:

$$h ( k , l ) = [ \begin{matrix}{h}_{1}^{( 1 )} ( k , l ) & {h}_{1}^{( 2 )} ( k , l ) & … & {h}_{1}^{( Np )} ( k , l ) \\ {h}_{2}^{( 1 )} ( k , l ) & {h}_{2}^{( 2 )} ( k , l ) & … & {h}_{2}^{( Np )} ( k , l ) \\ ⋮ & ⋮ & ⋱ & ⋮ \\ {h}_{Na}^{( 1 )} ( k , l ) & {h}_{Na}^{( 2 )} ( k , l ) & … & {h}_{Na}^{( Np )} ( k , l )\end{matrix} ]$$

Where Np is the total number of DMRS ports configured for UE by the NW node. \tilde{r}(k′, l′) is noise samples at the subcarrier index k′ and time index l′, given by:

$$\tilde{r} ( {k}^{′} , {l}^{′} ) = y ( {k}^{′} , {l}^{′} ) - {\sum }_{p} h ( {k}^{′} , {l}^{′} ) {d}_{DMRS}^{( p )} ( {k}^{′} , {l}^{′} )$$

Where y(k′, l′) is the (Nr×1) matrix of received OFDM symbols corresponding DMRS symbols transmitted at the subcarrier index k′ and time index l′.

$${d}_{DMRS}^{( p )} ( {k}^{′} , {l}^{′} )$$

is the transmitted DMRS symbols for DMRS port p, which is specified in the standard [1]. According to the standard, since one or more DMRS symbols are multiplexed to one OFDM symbols on (k′, l′).

As it is shown from the formula, MMSE-IRC receiver algorithm derives the transmitted symbols

$${d}_{PDSCH}^{( p )} ( k , l )$$

only from the DMRS symbols configured for UE. This means no calculation difference whether the NW node uses MU-MIMO or SU-MIMO from the UE point of view.
Enhanced Minimum Mean Square Error Receiver with Interference Rejection Combining (E-MMSE-IRC) Receiver Algorithm

E-MMSE-IRC receiver algorithm [4] is the enhanced MMSE-IRC which also considers the DMRS information not only configured for itself (assume UE1), but also configured for other (co-scheduled) UEs (e.g., UE2, UE3, . . . ). The difference from MMSE-IRC receiver algorithm is how to derive combining weights.

Assume UE1 demodulates PDSCH symbols with E-MMSE-IRC algorithm. The E-MMSE-IRC combining weights of PDSCH symbols on (k, l) for DMRS port p are given as follows:

$${w}_{E}^{( p )} ( k , l ) = {( {h}^{( p )} ( k , l ) )}^{H} {{R}_{E} ( k , l )}^{- 1}$$

Where h^{(p)}(k, l) is same as MMSE-IRC, (Nr×1) matrix of channel estimates corresponding to DMRS port p,

R_{E}(k, l), is (Nr×Nr) noise covariance matrix for E-MMSE-IRC derived from:

$${R}_{E} ( k , l ) = {h}_{own} ( k , l ) {h}_{own}^{H} ( k , l ) + {h}_{other} ( k , l ) {h}_{other}^{H} ( k , l ) + \frac{1}{{N}_{DMRS}} {\sum }_{( {k}^{′} , {l}^{′} ) ∈ DMRS} {\tilde{r}}_{E} ( {k}^{′} , {l}^{′} ) {\tilde{r}}_{E}^{H} ( {k}^{′} , {l}^{′} )$$

Where h_{own}(k, l) is (Nr×Np) matrix of channel estimates with element

$${h}_{i}^{( p )} ( k , l ) ,$$

where i is the receive antenna number and p is the DMRS antenna port number configured for UE1. Nr is the number of receive antenna of UE1 and Np is the number of DMRS ports configured for UE1.

hₒₜₕₑᵣ(k, l) is (Nr×Np,other) matrix of channel estimates

$${h}_{i}^{( p )} ( k , l ) ,$$

where i is the receive antenna number of UE1 and p is the DMRS antenna port number configured for other (co-scheduled) UEs (i.e., UE2, UE3, . . . ). Nr is the number of receive antenna of UE1 and Np,other is the total number of DMRS ports configured for other UEs (i.e., UE2, UE3, . . . ). N_{DMRS} is the number of DMRS symbols contributed to R_{E}(k, l).

\tilde{r}_{E}(k′, l′) is a matrix of noise samples on the subcarrier index k′ and time index l′, given by

$${\tilde{r}}_{E} ( {k}^{′} , {l}^{′} ) = y ( {k}^{′} , {l}^{′} ) - {\sum }_{p ∈ ownDMRS} {h}_{own} ( {k}^{′} , {l}^{′} ) {d}_{DMRS}^{( p )} ( {k}^{′} , {l}^{′} ) - {\sum }_{p ∈ otherDMRS} {h}_{other} ( {k}^{′} , {l}^{′} ) {d}_{DMRS}^{( p )} ( {k}^{′} , {l}^{′} )$$

Where y(k′, l′) is the (Nr×1) matrix of received OFDM symbols corresponding DMRS symbols transmitted on the subcarrier index k′ and time index l′.

$${d}_{DMRS}^{( p )} ( {k}^{′} , {l}^{′} )$$

is the transmitted DMRS symbols on (k′, l′) for DMRS port p. ownDMRS is a set of DMRS ports configured for UE1, and otherDMRS is a set of DMRS ports configured for other UEs (i.e., UE2, UE3, . . . ). For example if the NW node configures DMRS port 1 to UE1, DMRS port 0 to UE2, and DMRS ports 2 and 3 to UE3, ownDMRS={1} and otherDMRS={0, 2, 3} for UE1 point of view. On the other hand, if UE2 uses E-MMSE-IRC, ownDMRS={0} and otherDMRS={1, 2, 3}.

If NW node applies SU-MIMO, that is the NW node transmits PDSCH data streams only to UE1, there is no calculation difference between MMSE-IRC and E-MMSE-IRC because the set of otherDMRS is empty and no channel estimate matrix hₒₜₕₑᵣ(k, l). On the other hand, if the NW node applies MU-MIMO and transmits PDSCH to UE1 and other UEs (i.e., UE2, UE3, . . . ) at the same time, otherDMRS is not empty and UE1 requires to know DMRS information configured to other UEs (i.e., UE2, UE3, . . . ), e.g., configured DMRS ports and their DMRS sequence information.

### Reduced Complexity Maximum Likelihood (R-ML) Receiver Algothrim

R-ML receiver algorithm [4] is a variant on the maximum likelihood receiver algorithm, where computation complexity is reduced. There are several techniques to reduce the computational complexity of ML algorithm published so far. Here, one of the reduced complexity ML algorithms is described below.

### SU-MIMO Scenario

Assume UE1 demodulate PDSCH symbols,

$${d}_{P D S C H}^{( p )} ( k , l )$$

at subcarrier index k and time index l for DMRS port p, using R-ML receiver algorithm. R-ML starts from building the channel estimation matrix:

$$h ( k , l ) = [ \begin{matrix}{h}_{1}^{( 1 )} ( k , l ) & {h}_{1}^{( 2 )} ( k , l ) & … & {h}_{1}^{( Np )} ( k , l ) \\ {h}_{2}^{( 1 )} ( k , l ) & {h}_{2}^{( 2 )} ( k , l ) & … & {h}_{2}^{( Np )} ( k , l ) \\ ⋮ & ⋮ & ⋱ & ⋮ \\ {h}_{Na}^{( 1 )} ( k , l ) & {h}_{Na}^{( 2 )} ( k , l ) & … & {h}_{Na}^{( Np )} ( k , l )\end{matrix} ]$$

Where h(k, l) is (Nr×Np) matrix of channel estimates with element

$${h}_{i}^{( p )} ( k , l ) ,$$

where i is the receive antenna number of UE1 and p is the DMRS antenna port number configured for UE1. Nr is the number of receive antenna of UE1 and Np is the number of DMRS ports configured for UE1.

After getting the channel matrix, apply QR decomposition to the channel matrix, as follows:

$$h ( k , l ) = Q ( k , l ) R ( k , l )$$

Q(k, l) is (Nr×Np) matrix and R(k, l) is upper triangular (Np×Np) matrix. For example, if Nr=4, and Np=2, the matrix Q and R are given as follows:

$$Q = [ \begin{matrix}{q}_{11} & {q}_{12} \\ {q}_{21} & {q}_{22} \\ {q}_{31} & {q}_{32} \\ {q}_{41} & {q}_{42}\end{matrix} ] , R = [ \begin{matrix}{r}_{11} & {r}_{12} \\ 0 & {r}_{211}\end{matrix} ]$$

In the next step, solve the following equations for

$${d}_{PDSCH}^{( p )} ( k , l ) :$$

$$R ( k , l ) [ \begin{matrix}{d}_{PDSCH}^{( 1 )} ( k , l ) \\ {d}_{PDSCH}^{( 2 )} ( k , l ) \\ ⋮ \\ {d}_{PDSCH}^{( Np )} ( k , l )\end{matrix} ] = {y}^{′} ( k , l ) = {( Q ( k , l ) )}^{H} y ( k , l ) = {( Q ( k , l ) )}^{H} [ \begin{matrix}{y}_{1} ( k , l ) \\ {y}_{2} ( k , l ) \\ ⋮ \\ {y}_{Nr} ( k , l )\end{matrix} ]$$

where y(k, l) is the (Nr×1) matrix of received OFDM symbols for PDSCH, that is, y(k, l)=[y₁(k, l) y₂(k, l) . . . y_{Nr}(k, l)]^{T}, where yᵢ is the received PDSCH OFDM symbols at receive antenna i of UE1. By applying the Hermitian transportation of matrix Q(k, l), the matrix y(k, l) becomes y′(k, l), whose size is (Np×1). A^{H} is the Hermitian transportation of matrix A.

Since the matrix R is the upper triangular matrix, the equations can be easily solved in the order from

$${d}_{PDSCH}^{( Np )} ( k , l ) to {d}_{PDSCH}^{( 1 )} ( k , l ) .$$

For example, in the case of Nr=4 and Np=2, the equations for the symbol on (k, l) are given as follows:

$$[ \begin{matrix}{r}_{11} & {r}_{12} \\ 0 & {r}_{22}\end{matrix} ] [ \begin{matrix}{d}_{PDSCH}^{( 1 )} \\ {d}_{PDSCH}^{( 2 )}\end{matrix} ] = [ \begin{matrix}{r}_{11} {d}_{PDSCH}^{( 1 )} + {r}_{12} {d}_{PDSCH}^{( 2 )} \\ {r}_{22} {d}_{PDSCH}^{( 2 )}\end{matrix} ] = [ \begin{matrix}{y}_{1}^{′} \\ {y}_{2}^{′}\end{matrix} ]$$

$${d}_{PDSCH}^{( 2 )} = {y}_{2}^{′} / {r}_{22}$$

$${d}_{PDSCH}^{( 1 )} = ( {y}_{1}^{′} - {r}_{12} {d}_{PDSCH}^{( 2 )} ) / {r}_{11}$$

After solving the equations,

$${d}_{PDSCH}^{( p )} ( k , l )$$

is de-mapped to the closest symbols,

$${\hat{d}}_{PDSCH}^{( p )} ( k , l ) ,$$

according to the configured modulation order, e.g., 16QAM, 64QAM. As another example, it is possible to use the de-mapped symbols for each equation. For example, in the case of Np=2,

$${d}_{PDSCH}^{( 2 )} = {y}_{2}^{′} / {r}_{22}$$

is de-mapped to the closet symbols, e.g.,

$${\hat{d}}_{PDSCH}^{( 2 )} .$$

### Then

$${d}_{PDSCH}^{( 1 )}$$

is calculated using

$${\hat{d}}_{P DSCH}^{( 2 )} ,$$

that is,

$${d}_{PDSCH}^{( 1 )} = ( {y}_{1}^{′} - {r}_{12} {\hat{d}}_{PDSCH}^{( 2 )} ) / {r}_{11}$$

As yet another variant, it is also possible to keep the several closet symbol candidates for each DMRS port and select the set of PDSCH symbols which minimizes a metric. For example, after solving the equation, assume M candidate sets of PDSCH symbols are selected:

$$[ ( {\hat{d}}_{PDSCH , 1}^{( 1 )} , … , {\hat{d}}_{PDSCH , 1}^{( N p )} ) , … , ( {\hat{d}}_{PDSCH , M}^{( 1 )} , … , {\hat{d}}_{PDSCH \cdot M}^{( N p )} ) ] .$$

Then the final demodulated symbols are chosen so that the following metric is minimized:

$$( {d}_{PDSCH}^{( 1 )} , … , {d}_{PDSCH}^{( Np )} ) = {arg}_{i} min ‖ [ \begin{matrix}{y}_{1} ( k , l ) \\ {y}_{2} ( k , l ) \\ ⋮ \\ {y}_{Nr} ( k , l )\end{matrix} ] - R ( k , l ) [ \begin{matrix}{\hat{d}}_{PDSCH , i}^{( 1 )} ( k , l ) \\ {\hat{d}}_{PDSCH , i}^{( 2 )} ( k , l ) \\ ⋮ \\ {\hat{d}}_{PDSCH , i}^{( Np )} ( k , l )\end{matrix} ] ‖$$

where ∥.∥ is a norm.

### MU-MIMO Scenario

The R-ML algorithm can be also applied for MU-MIMO if the UE (e.g., UE1) knows the DMRS symbol information and modulation order information configured for other (co-scheduled) UEs (e.g., UE2, UE3, . . . ). For MU-MIMO scenario the channel estimation matrix is provide as follows:

$$h ( k , l ) = [ \begin{matrix}{h}_{1}^{( 1 )} ( k , l ) & {h}_{1}^{( 2 )} ( k , l ) & … & {h}_{1}^{( {Np}^{′} )} ( k , l ) \\ {h}_{2}^{( 1 )} ( k , l ) & {h}_{2}^{( 2 )} ( k , l ) & … & {h}_{2}^{( {Np}^{′} )} ( k , l ) \\ ⋮ & ⋮ & ⋱ & ⋮ \\ {h}_{Na}^{( 1 )} ( k , l ) & {h}_{Na}^{( 2 )} ( k , l ) & … & {h}_{Na}^{( {Np}^{′} )} ( k , l )\end{matrix} ]$$

Where h(k, l) is (Nr×Np′) matrix of channel estimates with element

$${h}_{i}^{( p )} ( k , l ) ,$$

where i is the receive antenna number and p is all the DMRS antenna port numbers used by the NW node (including both UE1 and other UEs (i.e., UE2, UE3, . . . )). Nr is the number of receive antenna of s UE1 and Np′ is the total number of DMRS ports configured for both UE1 and other UEs (i.e., UE2, UE3, . . . ).

The rest of procedure is the same as SU-MIMO case; the first step performs the QR decomposition to the channel matrix:

$$h ( k , l ) = Q ( k , l ) R ( k , l )$$

Then, solve the following equations for

$${d}_{PDSCH}^{( p )} ( k , l ) :$$

$$R ( k , l ) [ \begin{matrix}{d}_{PDSCH}^{( 1 )} ( k , l ) \\ {d}_{PDSCH}^{( 2 )} ( k , l ) \\ ⋮ \\ {d}_{PDSCH}^{( {Np}^{′} )} ( k , l )\end{matrix} ] = {( Q ( k , l ) )}^{H} [ \begin{matrix}{y}_{1} ( k , l ) \\ {y}_{2} ( k , l ) \\ ⋮ \\ {y}_{Nr} ( k , l )\end{matrix} ]$$

If the NW node applies MU-MIMO, if UE1 uses R-ML receiver algorithm, it should know the total number of DMRS ports and their DMRS sequence information configured by the NW node. On top of that, UE1 should also need to know the used modulation order information configured to other UEs (i.e., UE2, UE3, . . . ).

Hereafter provided is the performance comparison of different receiver algorithms, showing simulation results of different receiver algorithms for MU-MIMO: MMSE-IRC, E-MMSE-IRC and R-ML receiver algorithms. We show the simulation result for UE1 where NW node applies MU-MIMO and UE1 has knowledge the NW applies MU-MIMO and the DMRS information and modulation order information configured for other (co-scheduled) UEs (i.e., UE2, UE3, . . . )

### Comparison Results for Parameter Set 1

FIG. 5 shows one of the link simulation results of PDSCH throughput (i.e., PDSCH throughput comparison among three receiver algorithms (medium antenna correlation)) according to the parameters in Table 1. If we look the SNR points to achieve 70% (0.7) of relative throughput (which is normally used for 3GPP UE demodulation performance requirements [2]), it is shown R-ML receiver can achieve 70% with about 3.5 dB lower SNR level compared with MMSE-IRC, and E-MMSE-IRC receiver can achieve 70% with about 2.0 dB lower SNR level compared with MMSE-IRC.

TABLE 1
Simulation parameter set 1

| Parameters | Values |
|---|---|
| Channel model | TDL-A channel model with delay |
| | spread 30 ns and Doppler 10 Hz |
| UE1 receive antenna configuration | 4Rx, medium antenna correlation |
| MU-MIMO scheduling of for | QPSK, coding rate = 0.3, |
| own UE (UE1) PDSCH | 2 DMRS ports (2 MIMO streams) |
| MU-MIMO scheduling for | QPSK, coding rate = 0.3, |
| other UEs (UE2) PDSCH | 2 DMRS ports (2 MIMO streams) |

### Comparison Results for Parameter Set 2

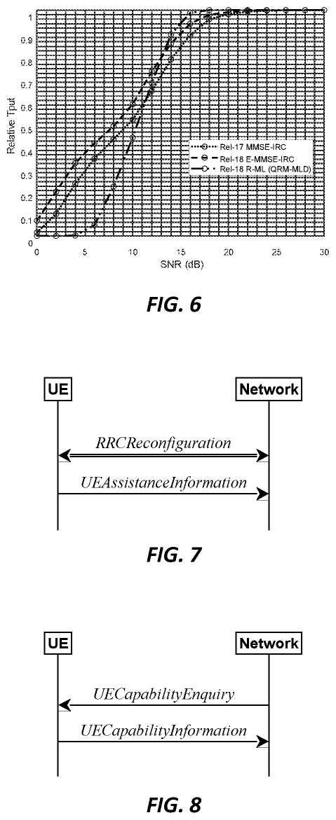

FIG. 6 shows another link simulation results (i.e., PDSCH throughput comparison among three receiver algorithms (no antenna correlation)) according to the parameters in Table 2. Unlike the parameter set 1, there is basically no performance difference among three algorithms with regard to the SNR level to achieve 70% of relative throughput.

TABLE 2
Simulation parameter set 2

| Parameters | Values |
|---|---|
| Channel model | TDL-A channel model with delay |
| | spread 30 ns and Doppler 10 Hz |
| UE1 receive antenna configuration | 4Rx, no antenna correlation |
| MU-MIMO scheduling of for | 16QAM, coding rate = 0.5, |
| own UE (UE1) PDSCH | 2 DMRS ports (2 MIMO streams) |
| MU-MIMO scheduling for | 16QAM, coding rate = 0.5, |
| other UEs (UE2) PDSCH | 2 DMRS ports (2 MIMO streams) |

### Summary of Comparison Results

The simulation results above show the E-MMSE-IRC and R-ML receivers do not always give better performance compared with MMSE-IRC.

Table 3 compares three receiver algorithms with regard to the computational complexity and required knowledge on other UEs (co-scheduled UEs). MMSE-IRC receiver algorithm is assumed to be used to set 3GPP UE demodulation requirements (a.k.a. baseline receiver algorithm), and it does not require any information on co-scheduled UEs even if the NW code applies MU-MIMO.

On the other hand, E-MMSE-IRC algorithm is more complex because it needs to calculate noise samples based on DMRS symbols configured not only for itself, but also for co-scheduled UEs. This means E-MMSE-IRC requires to know the existence of co-scheduled UEs and DMRS information configured for co-scheduled UEs.

R-ML is even more complex because it requires QR decomposition and metric evaluation to find the best set of PDSCH symbols minimizing the metric. As same as E-MMSE-IRC, R-ML requires to know the existence of co-scheduled UEs and DMRS information configured for co-scheduled UEs. R-ML also requires the modulation order information configured for co-scheduled UEs.

TABLE 2
Comparison of receiver algorithms for MU-MIMO.

| Receiver | | Knowledge of other (co-scheduled) |
|---|---|---|
| algorithm type | Computation complexity | UEs |
| MMSE-IRC | Baseline of 3GPP UE demodulation | Not necessary. |
| | performance requirements | |
| E-MMSE-IRC | Medium compared with MMSE-IRC | Existence of co-scheduled UEs |
| | | DMRS information |
| R-ML | High compared with MMSE-IRC | Existence of co-scheduled UEs |
| | | DMRS information |
| | | Modulation order information |

### NW Assistance Information (NAI)

In order to reduce the computation on the UE, the network node may provide assistance information, called network assistance information (NAI). The NAIs are provided on several layers according to the type of assistance, e.g., RRC layer or physical layer. When the NAIs are provided on RRC layer, the information is provided as cell-specific e.g., using the system information (SI) or UE-specific e.g., using PDSCH configuration setup.

When the NAIs are provided on physical layer, the information is provided in downlink control information (DCI) on control channel (PDCCH).

### UE Assistance Information (UAI)

3GPP specifies the framework on UE assistance information (UAI) reporting.

The purpose of this UAI reporting is for the UEs to allows to inform the network of its preference on features such as overheating, maximum number of MIMO layers (streams) for power saving, maximum aggregated bandwidth for power saving, etc.

FIG. 7 shows the RRC procedure on UE assistance information reporting [5]. As an example, when a UE is capable of providing its preference on the maximum number of MIMO layers, the UE may initiate the procedure in several cases, if it was configured to do so, including upon having a maximum number of MIMO layers preference and upon change of its maximum number of MIMO layers preference.

As another example, when a UE is capable of providing its preference on the maximum aggregated bandwidth, the UE may initiate the procedure in several cases, if it was configured to do so, including upon having a maximum aggregated bandwidth preference and upon change of its maximum aggregated bandwidth preference.

### UE Capability Signaling

3GPP specifies the framework on UE capability reporting. The purpose of this procedure is for the UE to inform the network of its supported capabilities/features specified in the capability/feature list in the standard [6]. FIG. 8 shows the RRC procedure on UE capability reporting [5].

One of the UE capabilities UE need to report is the receiver algorithm type. One example on UE receiver algorithm capability is the enhanced receiver algorithm for the scenario the UE receives PDSCH from several transmission points (RRH or TRP) in the single frequency network (SFN) under high speed train (HST) mobility condition, as shown in the standard as follows [5][6].

HighSpeedParameters-r16 ::= SEQUENCE {

| | | |
|---|---|---|
| measurementEnhancement-r16 | ENUMERATED {supported} | OPTIONAL, |
| demodulationEnhancement-r16 | ENUMERATED {supported} | OPTIONAL |

}

Definitions for parameters

demodulationEnhancement-r16
Indicates whether the UE supports the enhanced demodulation processing for HST-SFN joint
transmission scheme with velocity up to 500 km/h as specified in TS 38.101-4 [18]. This field applies
to MN configured demodulation enhancement when MR-DC is not configured and SN configured
demodulation enhancement when (NG)EN-DC is configured.
measurementEnhancement-r16
Indicates whether the UE supports the enhanced intra-NR and inter-RAT E-UTRAN RRM
requirements for MN configured measurement enhancement when MR-DC is not configured, and
the enhanced intra-NR RRM requirements for SN configured measurement enhancement when
(NG)EN-DC is configured, to support high speed up to 500 km/h as specified in TS 38.133.

In terms of applying MIMO receiver algorithms, there are problems with the current NR standard. For example, with reference to the above Table 3, E-MMSE-IRC and/or R-ML receiver algorithm may improve the UE receiver performance when the NW node applies MU-MIMO, but at the current NR standard, there is no mechanism for UE to know the NW node applies MU-MIMO or not, that is, UE does not know received PDSCH symbols are interfered by co-scheduled UE or not. Further, even if UE knows the existence of co-scheduled UE(s), UE does not know which DMRS port(s) are used by co-scheduled UE(s) and their DMRS/modulation information.

On the other hand, the NW node does not know UE's capability on receiver algorithm for MU-MIMO scenario, i.e., whether the UE can support MMSE-IRC only or it can support advanced MU-MIMO receiver algorithms: E-MMSE-IRC and/or R-ML. Further, the NW node does not know what NAI sets should be provided for the UE(s) capable of advanced MU-MIMO receiver algorithms if the NW node wants UE(s) to enable advanced MU-MIMO receiver algorithms.

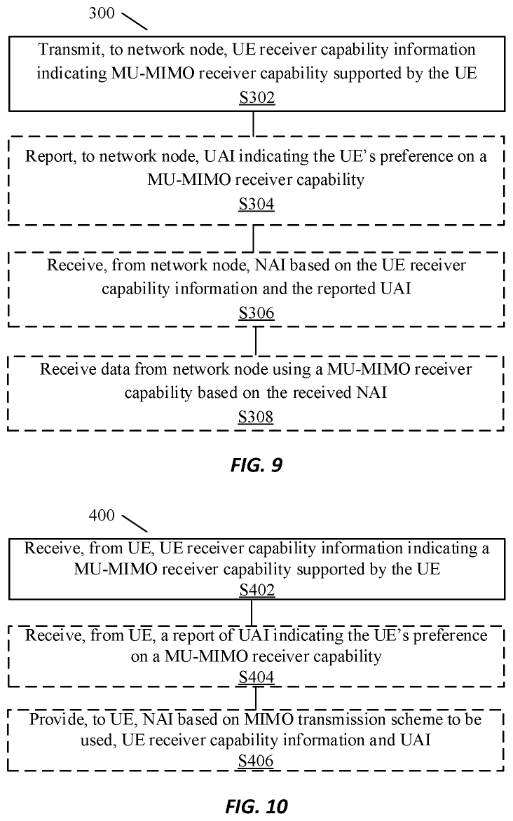

In view of at least the above problems, the present disclosure provides techniques for enabling determination or selection among UE receiver capabilities for MIMO data transmission. FIG. 9 shows an exemplary method 300 in a UE according to various embodiments of the present disclosure. As shown in FIG. 9, the method 300 may include an operation S302 of transmitting, to a network node connected to the UE, UE receiver capability information indicating an MU-MIMO receiver capability supported by the UE. Here, the MU-MIMO receiver capability includes at least one advanced MU-MIMO receiver capability. For example, the advanced MU-MIMO receiver capability may include one or more of E-MMSE-IRC and R-ML receiver capabilities or algorithms, which may be also called as:
Advanced MU-MIMO receiver type 1: E-MMSE-IRC receiver algorithm, or equivalent receiver algorithm.
Advancer MU-MIMO receiver type 2: R-ML receiver algorithm, or equivalent receiver algorithm.

In some embodiments, the UE may transmit the UE receiver capability information to the network node autonomously or upon receiving a UE capability enquiry from the network node. In the latter case, the transmission of UE receiver capability may be performed by using the framework of UE capability reporting described above with reference to FIG. 8.

In some embodiments, the UE receiver capability information may further indicate one or more of:
the maximum number of MIMO layers the UE can receive,
the maximum modulation order supported by the UE, and
the number of receive antenna panels the UE can receive simultaneously.

In some embodiments, the UE receiver capability information is provided by the UE separately for each Component Carrier (CC), or for a group of CCs, or for all CCs supported by the UE, and/or the UE receiver capability information is provided by UE separately for each frequency band, or for a group of frequency bands, or for all frequency bands.

The method 300 may optionally include, as shown in a dashed block, an operation S304 of reporting, to the network node, UAI indicating the UE's preference on an MU-MIMO receiver capability. The UE may report the UAI to the network node autonomously or upon receiving a request for UAI from the network node. In the latter case, the transmission of UAI may be performed by using the framework of UAI reporting described above with reference to FIG. 7.

In some embodiments, the UAI may include one or more elements representing information of one or more co-scheduled UEs, which are connected to the network node and to which the network node transmits data simultaneously with the UE by using MU-MIMO transmission. The information of one or more co-scheduled UEs may include one or more of:
existence of the one or more co-scheduled UEs,
DMRS port information used by the one or more co-scheduled UEs including port numbers and DMRS sequence information, and
modulation order used by the one or more co-scheduled UEs.

In some embodiments, after the UE receives an RRC reconfiguration message, the UE may transmit its preferred UAI elements via higher layer, e.g., UAI message. The UAI message structure may be shown as follows, where the UE may report a list of preferred UAI elements on the MU-MIMO receiver.

| CoScheduledUE-Info ::= SEQUENCE { | |
|---|---|
| exist-CoScheduledUE | BOOLEAN, |
| dmrs-Info | BOOLEAN, |
| maxModulationOrder | BOOLEAN |

}

In another example, the UE may report the UAI set for the MU-MIMO receiver which may be preconfigured based on the standard specification e.g. pre-defined in the standard.

Example of UAI sets is:
UAI set 1: Existence of co-scheduled UE(s)
UAI set 2: Existence of co-scheduled UE(s), DMRS port information
UAI set 3: Existence of co-scheduled UE(s), DMRS port information, Modulation order information

The UAI message structure may be shown as follows:

CoScheduledUE-Info :: = SEQUENCE {
coScheduledUE-Info ENUMERATED {set1, set2, set3}
}

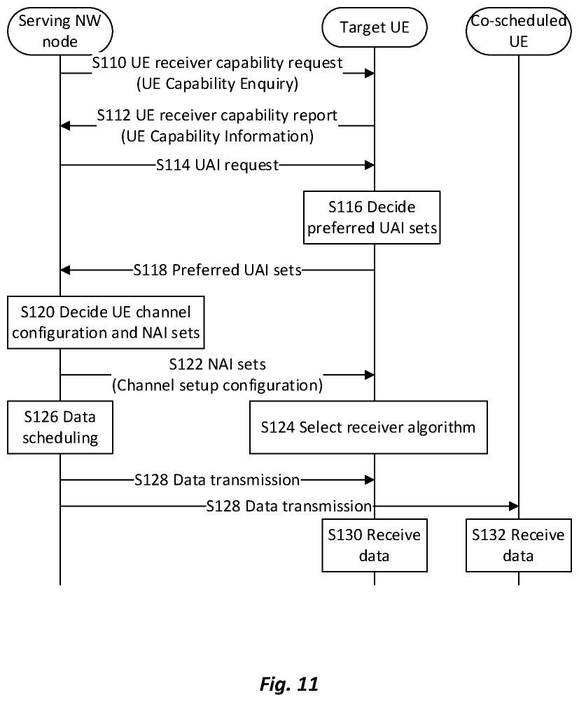

In some embodiments, the UAI may further depend on one or more conditions related to the UE's operation. In other words, the UE may determine or decide the UAI to be reported further based on the conditions. The conditions related to the UE's operation may be, for example, UE receive antenna correlation, UE internal condition/resource, UE reception signal quality, UE coverage status/level in a cell, UE mobility state, UE power saving operational mode, etc. These conditions may be pre-defined, configured by the network node, or autonomously determined by the UE. Examples of the conditions will be described later in connection with FIG. 11.

In some embodiments, the UAI may indicate only the existence of the one or more co-scheduled UEs if one or more of the following is met:
the UE does not support any advanced MU-MIMO receiver capability;
the UE cannot finish data channel decoding within a processing time when the UE uses an advanced MU-MIMO receiver capability;
the UE supports E-MMSE-IRC receiver capability but the UE's receive antenna correlation is low for a configured frequency band;
the UE has a poor reception signal quality;
the UE has an enhanced coverage level in a cell;
the UE has a high mobility state;
the UE has an internal condition/resource that does not allow use of an advanced MU-MIMO receiver capability; or
the UE is not operating in a power saving operational mode.

In some embodiments, the UAI may indicate both of the existence of the one or more co-scheduled UEs and the DMRS port information used by the one or more co-scheduled UEs, or all of the existence of the one or more co-scheduled UEs, the DMRS port information used by the one or more co-scheduled UEs and the modulation order used by the one or more co-scheduled UEs, if one or more of the following is met:
the UE can finish data channel decoding within a processing time when the UE uses an advanced MU-MIMO receiver capability;
the UE has a good reception signal quality;
the UE has a normal coverage level in a cell;
the UE has a low/normal mobility state;
the UE has an internal condition/resource that allows use of an advanced MU-MIMO receiver capability; or
the UE is operating in a power saving operational mode.

In some embodiments, the UAI may indicate both of the existence of the one or more co-scheduled UEs and the DMRS port information used by the one or more co-scheduled UEs, if the UE supports E-MMSE-IRC receiver capability but the UE's receive antenna correlation is medium or high for a configured frequency band.

In some embodiments, the UAI may indicate all of the existence of the one or more co-scheduled UEs, the DMRS port information used by the one or more co-scheduled UEs and the modulation order used by the one or more co-scheduled UEs, if the UE supports R-ML receiver capability but the UE's receive antenna correlation is medium or high for a configured frequency band.

Regarding how to determine the UAI to be reported to the network node, examples will be described later in connection with FIG. 11.

In some embodiments, the UE may report the UAI per-band, per-carrier, per group of carriers, per Frequency Range (FR) or per-Transmission Reception Point (TRP).

In some embodiments, the UE may not report any UAI on the UE's preference on an MU-MIMO receiver capability, if the UE does not support any advanced MU-MIMO receiver capability, or if the UE is not scheduled to use or cannot use any advanced MU-MIMO receiver capability.

The method 300 may optionally include, as shown in a dashed block, an operation S306 of receiving, from the network node, Network Assistance Information (NAI) that is determined by the network node based on the UE receiver capability information and the reported UAI, and an operation S308 of receiving data from the network node by using an MU-MIMO receiver capability. The MU-MIMO receiver capability may be based on the received NAI.

In some embodiments, the UE may receive the NAI at a data channel configuration setup from the network node. The NAI may indicate one or more of:
existence of one or more co-scheduled UEs,
DMRS port information used by the one or more co-scheduled UEs including port numbers and DMRS sequence information, and
modulation order used by the one or more co-scheduled UEs.

Examples of NAI elements may be shown below. In one example, the NW node may indicate in the NAI sent to the UE, the maximum modulation order which are common for co-scheduled UEs.

exist-CoScheduledUE BOOLEAN
CoScheduledUE-DMRS-InfoList ::= SEQUENCE (SIZE
(1..maxNrofDMRSPorts) ) of CoScheduledUE-DMRS-Info
CoScheduledUE-DMRS-Info ::= SEQUENCE {
DMRSInfo SEQUENCE{

| | |
|---|---|
| dmrs-port | INTEGER {0..11}, |
| scramblingID0 | INTEGER {0..65535}, |
| scramblingID1 | INTEGER {0..65535}, |
| nScid | INTEGER {0, 1} |

```
      }
    }
}
maxModulationOrder  ENUMERATED {qam64, qam256, qam1024}
```

In another example, the maximum modulation order information may be informed per DMRS ports in the NAI as follows:

exist-CoScheduledUE BOOLEAN
CoScheduledUE-DMRS-InfoList ::= SEQUENCE (SIZE
(1..maxNrofDMRSPorts) ) of CoScheduledUE-DMRS-Info
CoScheduledUE-DMRS-Info ::= SEQUENCE {
DMRSInfo SEQUENCE{

| | |
|---|---|
| dmrs-port | INTEGER {0..11}, |
| scramblingID0 | INTEGER {0..65535}, |
| scramblingID1 | INTEGER {0..65535}, |
| nScid | INTEGER {0, 1}, |
| maxModulationOrder | ENUMERATED {qam64, qam256, |
| | qam1024} |

```
      }
    }
}
```

In some embodiments, the UE may decide to use which MU-MIMO receiver capability for data reception. For example, at the operation S308, the used MU-MIMO receiver capability may be an MMSE-IRC receiver capability, if the UE does not receive any NAI from the network node, or the received NAI indicates only the existence of one or more co-scheduled UEs. In another example, the used MU-MIMO receiver capability may be the E-MMSE-IRC receiver capability, if the UE supports the E-MMSE-IRC receiver capability, and the received NAI indicates both of the existence of one or more co-scheduled UEs and the DMRS port information used by the one or more co-scheduled UEs. In yet another example, the used MU-MIMO receiver capability may be the R-ML receiver capability, if the UE supports the R-ML receiver capability, and the received NAI indicates all of the existence of one or more co-scheduled UEs, the DMRS port information used by the one or more co-scheduled UEs and the modulation order used by the one or more co-scheduled UEs.

In some embodiments, the UE may decide to use MU-MIMO receiver capability for data reception further based on one or more conditions including one or more of the UE's baseband processor load, the UE's scheduled channel bandwidth, the UE's measured channel decoding error rate, and the UE's measured channel condition. In an example, the used MU-MIMO receiver capability may be an MMSE-IRC receiver capability, instead of the E-MMSE-IRC receiver capability or the R-ML receiver capability, if:
the UE's baseband processor load is so high that the UE cannot finish channel decoding within a specified timeline when the UE uses the E-MMSE-IRC receiver capability or the R-ML receiver capability,
the UE's channel decoding error rate is low, or
the UE's channel condition is poor.

In another example, the used MU-MIMO receiver capability may be the E-MMSE-IRC receiver capability, instead of the R-ML receiver capability, if:
the UE's baseband processor load is so high that the UE cannot finish channel decoding within a specified timeline when the UE uses the R-ML receiver capability,
the UE's channel decoding error rate is low,
the UE's channel condition is poor, or
the one or more co-scheduled UEs uses lower modulation orders.

Detailed examples of how to decide the MU-MIMO receiver capability will be given later with reference to FIG. 11.

In some embodiments, the method 300 may further include an operation of, during receiving data from the network node, continuously monitoring the one or more conditions and determining the MU-MIMO receiver capability to be used for data reception based on the monitored conditions.

FIG. 10 shows an exemplary method 400 in a network node according to various embodiments of the present disclosure. The method 400 may include an operation S402 of receiving, from a UE connected to the network node, UE receiver capability information indicating an MU-MIMO receiver capability supported by the UE. The MU-MIMO receiver capability may include at least one advanced MU-MIMO receiver capability.

In some embodiments, the advanced MU-MIMO receiver capability may include one or more of E-MMSE-IRC and R-ML receiver capabilities or algorithm.

In some embodiments, the network node may transmit a UE capability enquiry to the UE, and then receive the UE receiver capability information provided by the UE in response to the enquiry.

In some embodiments, the method 400 may optionally include, as shown in a dashed block, an operation S404 of receiving, from the UE, a report of UAI indicating the UE's preference on an MU-MIMO receiver capability.

In some embodiments, the network node may transmit a request for UAI to the UE, and then receive the UAI provided by the UE in response to the request.

In some embodiments, the network node may not receive the UAI from the UE, if the UE receiver capability information indicates no advanced MU-MIMO receiver capability supported by the UE.

In some embodiments, the network node may maintain the received UE receiver capability information and the reported UAI. In an example, the network node may, based on the reported information e.g., UE capability and UAI on the MU-MIMO receiver, maintain the UE capability list of supported advanced MU-MIMO receiver algorithm capabilities and the UAI on the MU-MIMO receiver for each connected UE, as shows in Table 3.

TABLE 3
Example of maintained UE capability list.

| | Reported advanced MU-MIMO | Preferred UAI on the |
|---|---|---|
| Connected UE | receiver algorithm capabilities | MU-MIMO receiver |
| UE 1 | Type 1 and Type 2 | UAI set 3 |
| UE 2 | Type 1 only | UAI set 1 |
| UE 3 | Type 2 only | UAI set 2 |
| UE 4 | None | None |
| UE X | . . . | . . . |

In some embodiments, the network node may determine a MIMO transmission scheme to be used for data transmission based on at least a transmitter capability of the network node and/or the received UE receiver capability information. In an example, the network node may determine not to use an MU-MIMO transmission scheme for data transmission to the UE, if:
the network node does not have a capability of MU-MIMO transmission,
the received UE receiver capability information indicates no advanced MU-MIMO receiver capability supported by the UE,
the network node needs to schedule data transmission to only the one UE, or
downlink traffic load is not so high that the network node does not need to use the MU-MIMO transmission scheme.

Regarding how to determine the MIMO transmission scheme to be used for data transmission, examples will be described later in connection with FIG. 11.

In some embodiments, the method 400 may optionally include, as shown in a dashed block, an operation S406 of providing, to the UE, NAI based on the MIMO transmission scheme determined by the network node, the received UE receiver capability information and the reported UAI.

In some embodiments, the network node may determine what NAI to be provided to the UE. In an example, the determined NAI may indicate only existence of one or more co-scheduled UEs if the network node determines to use the MU-MIMO transmission scheme and the received UE receiver capability information indicates no advanced MU-MIMO receiver capability supported by the UE.

In another example, if the network node determines to use the MIMO transmission scheme and the received UE receiver capability information indicates one or more advanced MU-MIMO receiver capability supported by the UE, the determined NAI may, according to the received UAI, indicate one or more of:
existence of one or more co-scheduled UEs,
DMRS port information used by the one or more co-scheduled UEs including port numbers and DMRS sequence information, and
modulation order used by the one or more co-scheduled UEs.

Regarding how to determine the NAI to be provided to the UE, examples will be described later in connection with FIG. 11.

In some embodiments, the network node may provide the determined NAI at a data channel configuration setup with the UE.

In some embodiments, the network node may not determine or provide the NAI if:
the network node determines not to use an MU-MIMO transmission scheme for data transmission to the UE,
the received UE receiver capability information indicates no advanced MU-MIMO receiver capability supported by the UE, or
the network node does not receive a report of the UAI from the UE.

In some embodiments, the method 400 may further include an operation of transmitting data to the UE by using the determined MIMO transmission scheme.

In some embodiments, the network node may transmit data to the UE and one or more of the co-scheduled UEs having the same MU-MIMO receiver capability as the UE. For example, when scheduling data, the network node may co-schedule the UEs which have the same MU-MIMO receiver algorithm capabilities, for example, UE1 and UE2 in Table 4 having the receiver type 1, and UE1 and UE3 in Table 4 having the receiver type 2.

The above describes the methods at the UE and network node sides separately. In the following, an exemplary flow between the UE and the network node will be described.

FIG. 11 shows an exemplary flow of a procedure of determining or selecting among UE receiver capabilities for MIMO data transmission according to various embodiments of the present disclosure. The flow involves a target UE, and a network node serving the target UE and the co-scheduled UE. In the following, the target UE will be referred to as UE and the serving network node will be referred to as network node for simplicity.

At operation S110, the NW node acquires the receiver capability information on MU-MIMO receiver algorithm from the UE. The receiver capability information may be acquired by transmitting a UE receiver capability request with, e.g., UE Capability Enquiry message, to the UE.

At operation S112, After the UE receives the UE Capability Enquiry message, the UE reports its capability information with e.g., UE Capability Information message. The UE may inform information related to its receiver capability for MU-MIMO scenario to the NW node via higher layer signaling e.g. via RRC message.

Alternatively, the UE may transmit its receiver capability information to the NW node autonomously, without receiving a request from the NW node.

In the UE capability Information message, the UE includes its MU-MIMO receiver algorithm/capability information. The advanced MU-MIMO receiver algorithm/capability includes two or more receiver type options, for example,
Advanced MU-MIMO receiver type 1: Enhanced Minimum Mean Square Error receiver with Interference Rejection Combining (E-MMSE-IRC receiver), or equivalent receiver algorithm.
Advancer MU-MIMO receiver type 2: Reduced complexity Maximum Likelihood receiver (R-ML receiver), or equivalent receiver algorithm.

The UE receiver capability may also include the maximum number of MIMO layers the UE can receive. The example of the maximum number is 2, 4, or 8.

The UE receiver capability may also include the maximum modulation order supported by the UE. The example of modulation order is 16QAM, 64QAM, 256QAM, 1024QAM tec.

The UE receiver capability may also include the number of receiver antenna panels UE can receive simultaneously, which is mainly signaled for higher frequency bands such as 28 GHz or 40 GHz. The example of the number of the received antenna panels UE can receive simultaneously is 1, 2, 3, 4 etc.

Any one or more parameters related to the above UE receiver capability may be indicated by the UE separately for each component carrier (CC) (e.g. one carrier frequency of a serving cell) or for a group of CCs (e.g. a group of carrier frequencies of a corresponding group of serving cells) or for all the CCs supported by the UE (e.g. all carrier frequencies of all the corresponding serving cells supported by the UE). In another example, any one or more parameters related to the above UE receiver capability may be applicable per frequency band e.g. apply for a group of CCs or for all the CCs supported by the UE in that band.

At operation S114, the NW node may acquire the preferred UE assistance information (UAI) on MU-MIMO receiver from the UE which is capable of one or more advanced MU-MIMO receiver algorithm capabilities. The preferred UAI elements are acquired by enabling the UE to report UAI with e.g., UE Assistance Information message. The example of preferred UAI on MU-MIMO receiver has been explained above.

The NW node may not acquire the preferred UAI on MU-MIMO receiver from the UE, for example, if the NW node does not schedule MU-MIMO transmission or the NW node does not have the functionality of MU-MIMO transmission. In this case, the NW node may disable the UAI reporting on the MU-MIMO receiver algorithm. This in turn forbids the UE to transmit any UAI element related to its MU-MIMO receiver.

At operation S116, the UE may decide what UAI to be reported to the NW node depending on the UE's receiver capability and one or more conditions related to the UE operation. Examples of the one or more conditions, which may be pre-defined, configured by NW node or autonomously determined by the UE, may include one or more of:
UE receive antenna correlation, e.g., higher correlation, medium correlation, lower or no correlation among receive antennas;
UE internal condition/resources, e.g., remaining battery level, baseband processor load, available memory resource etc.;
Reception signal quality, e.g., based on a relation between the channel reception BLER estimated by the UE and a threshold (H11), a relation between the number of HARQ ACK and/or HARQ NACK detected by the UE and their respective thresholds (H12, H13), a relation between the measured or reported CSI (e.g., CQI) and a threshold (H14). The thresholds, H11, H12, H13 and H14 can be pre-defined or configured by a network node;
UE coverage status/level in a cell, which may be determined based on a relation between a received signal level (RSL) measured by the UE on a reference signal (e.g. SSB, CSI-RS etc.) of a serving cell and a threshold (H21). Examples of RSL are received signal strength (RSS) and received signal quality (RSQ). Examples of RSL are path loss, RSRP, L1-RSRP etc. Examples of RSQ are SNR, SINR, RSRQ, L1-SINR etc. For example, the UE coverage level is high or enhanced if RSL<H; otherwise the UE coverage level is low or normal. In another example, the UE coverage level is high/enhanced if [(RSS<H22) and/or (RSQ<H23)]; otherwise the UE coverage level/normal is low. The thresholds, H21, H22 and H23 can be pre-defined or configured by a network node;
UE mobility state, e.g. UE speed, UE acceleration, UE direction of motion etc. For example, the UE may decide whether to send the UAI is based on the UE speed. The UE speed can be determined or expressed in terms of distance per unit time (e.g. in X1 km/hour) and/or in Doppler frequency (e.g. X2 Hertz). The UE may determine its speed autonomously by estimating Doppler frequency and/or by estimating the changes in the RSL and/or by receiving an assistance information/indication from a network node (e.g. speed flag/indicator). For example, the UE operating in a high speed environment may be indicated by the NW node that the UE is operating in high speed environment (e.g. where the speed is up to X3 km/hour such as up to 350 km/hour).;
UE power saving operational mode; the UE may be configured to operate in one or more power saving operational modes. The UE operates in the configured mode if the UE also meets the respective criterion. This allows the UE to save its power. Examples of the criteria are, UE operates in low mobility, UE is stationary, UE is not-at-cell-edge etc. In power saving mode the UE performs one or more radio link procedures (RLPs) using relaxed measurements. A relaxed measurement is performed over a measurement time which is longer than the measurement time of the non-relaxed measurements. Examples of the measurements are L1-RSRP, radio link quality estimation (e.g. SNR, SINR etc.) etc. The measurements for the RLPs are performed on reference signals (e.g. SSB, CSI-RS etc.) transmitted by the serving cell. Examples of the RLP are radio link monitoring (RLM), beam failure detection (BFD), candidate beam detection (CBD) etc.

In an embodiment, the UE may report UAI sets for the MU-MIMO receiver, which may be preconfigured based on the standard specification, e.g. pre-defined in the standard. Example of UAI sets is:
UAI set 1: Existence of co-scheduled UE(s)
UAI set 2: Existence of co-scheduled UE(s), DMRS port information
UAI set 3: Existence of co-scheduled UE(s), DMRS port information, Modulation order information.

Examples of preferred UAI reporting according to one or more conditions may be as follows.
Example 1: UE reports UAI set 1 if the UE does not support capability of advanced MU-MIMO receiver algorithms.
Example 2: UE reports UAI set 1 if the UE may not finish data channel (e.g. PDSCH) decoding within the processing time (T1) if the UE uses advanced MU-MIMO receiver algorithm. It happens for example when the NW node configures very wide channel bandwidth such as CA/DC configuration with several serving carriers (e.g. one or more sPCell and/or one or more SCells). The processing time T1 may be pre-defined/specified, configured by the network node or autonomously determined by the UE (e.g. based on internal resources). Examples of sPCell are PCell, PSCell etc. In another example, if the UE can finish data channel (e.g. PDSCH) decoding within the specified processing time then the UE may report UAI set 2 or UAI set 3. The selection between UAI set 2 and UAI set 3 further depends on how fast the UE can decode the data channel with T1.
Example 3: UE reports UAI set 1 if the UE supports E-MMSE-IRC receiver but the receive antenna correlation is below threshold (i.e., low) for the configured frequency band.
Example 4: UE reports UAI set 2 if the UE supports E-MMSE-IRC receiver and the receiver antenna correlation exceeds a threshold (i.e., medium/high) for the configured frequency band.
Example 5: UE reports UAI set 3 if the UE supports R-ML receiver and the receive antenna correlation is medium/high for the configured frequency band.
Example 6: UE reports UAI set 1 if the channel (e.g. PDSCH) reception BLER estimated by the UE is above certain threshold and/or if the measured/reported CSI (e.g., CQI) by the UE is below certain threshold. Otherwise the UE may report UAI set 2 or UAI set 3.
Example 7: UE reports UAI set 1 if the UE coverage level in the cell (e.g. in the serving cell) is high/enhanced; Otherwise (i.e. if the UE coverage level is low/normal) the UE may report UAI set 2 or UAI set 3.
Example 8: UE reports UAI set 1 if the UE mobility state is high (e.g. if the UE speed is above threshold); Otherwise (i.e. if the UE speed is below threshold) the UE may report UAI set 2 or UAI set 3.
Example 9: UE reports UAI set 1 if at least one set/type of UE internal resources is below threshold; Otherwise, the UE may report UAI set 2 or UAI set 3. For example, the UE internal resource is below certain threshold if the UE battery is below certain threshold and/or the available UE memory is below certain threshold and/or the available UE processing resources/processor units is below certain threshold.
Example 10: UE reports UAI set 2 or set 3 if the UE is operating in at least one power saving mode e.g. not-at-cell edge, stationary etc. Otherwise, the UE may report UAI set 1. This is because, the UE being in power saving mode can conserve power for using more advance MIMO receiver e.g. R-ML or E-MMSE-IRC etc.

The UE may report the preferred UAI elements or UAI set per-band, per-carrier, per group of carriers, per frequency range (FR) (e.g. per FR1, per FR2, per FR2-1, per FR2-2 etc.), per-TRP.

At operation S118, the UE may transmit the decided UAI on the MU-MIMO receiver to the NW node. The UE may transmit the UAI autonomously or in response to receiving a request from the NW node.

The operation of transmitting the UAI may be executed when the NW node performs the re-configuration for the RRC setup in the case when the UAI reporting is enabled. For example, after the UE receives the RRC reconfiguration message, the UE may transmit its preferred UE assistance information (UAI) elements via higher layer, e.g., UE Assistance Information message, as shown in FIG. 7. The preferred UAI means the type of information/assistance data required by the UE from the NW node in order for the UE to optimally or efficiently apply certain receiver type for receiving signals from a serving cell.

At operation 120, the NW node may decide data channel configuration for the UE and the NW assistance information (NAI) to be provided to the UE.

In this operation, when transmitting downlink data to a connected UE, the NW node configures the data channel (e.g., PDCCH/PDSCH) to the target UE. When the NW node configures the data channel to the UE, the NW node checks whether the UE has advanced MU-MIMO receiver algorithm capabilities or not, and whether the UE reported any preferred UAI element. According to the UE receiver capabilities and preferred UAI elements as well as the NW node transmitter capability, the NW node may determine the MIMO transmission scheme (e.g., SU-MIMO and/or MU-MIMO) to be used and what NAI elements may be provided to the UE if the UE has the capability of the advanced MU-MIMO receiver algorithm and has preferred UAI elements.

The NAI elements provided to the UE may depend on the NW node transmission scheduling, the reported UE receiver capabilities and preferred UAI elements. Examples are provided below.
Example 1: If the NW node does not use MU-MIMO (e.g., the NW node does not have the functionality of MU-MIMO transmission, or the downlink traffic load is not so high that the NW node does not need to use MU-MIMO), then the NW node does not provide any NAI elements, regardless the UE has advanced MU-MIMO receiver algorithm capabilities or not.
Example 2: If the UE does not have any advanced MU-MIMO receiver algorithm capabilities, the NW node does not provide any NAI elements.
Example 3: Even if the UE does not have any advanced MU-MIMO receiver algorithm capabilities, the NW node provides the NAI element ‘Existence of co-scheduled UE(s)’.
Example 4: If the UE is capable of one or more advanced MU-MIMO receiver algorithm capabilities, and if the UE reports several preferred UAI elements on the MU-MIMO receiver, the NW node provides the NAI elements according to the preference.
Example 5: If the UE is capable of one or more advanced MU-MIMO receiver algorithm capabilities, but the UE does not report any UAI elements on the MU-MIMO receiver, the NW node does not provide any NAI elements.

At operation S122, after the determination of the NAI elements, the NW node may transmit the NAI elements at the same time the NW transmits the channel configuration set, e.g., PDCCH-Config or PDSCH-Config.

The UE may receive the data channel configuration setup from the NW node via higher layer signaling e.g. RRC message, DCI, MAC-CE etc. The example of data channel configuration setup is UE-specific PDSCH configuration (or PDSCH-Config).

At the data channel configuration setup, the UE may receive at least the following configuration information elements:
DMRS configuration
   This information includes the demodulation reference signal (DMRS) information, for example, DMRS sequence generation information, such as random seed of pseudo-random sequence (e.g., Scrambling ID0/ID1).
   This information also includes the maximum number of transmission ports (or DMRS ports) the NW node uses during the data transmission. If the NW node is going to transmit up to 8 MIMO layers, UE is configured with 8 DMRS ports. This means the UE should prepare the baseband processing unit to receive 8 different DMRS sequences for channel estimation.
Maximum modulation order information
   This information also includes the maximum modulation order the NW may use to modulate the data symbols (e.g., 64QAM, 256QAM, 1024QAM)
Carrier frequency information
   This information indicates one or more carrier frequencie(s) in certain frequency band(s) that may be used by the NW node to transmit the data. Example of frequency bands n1 (2 GHz band), n28 (700 MHz band), n77/n78 (4 GHz band), n257 (28 GHz band) and n259 (40 GHz band). The information may comprise one or more of a DL carrier frequency channel number (e.g. ARFCN, NR-ARFCN etc), an UL carrier frequency channel number (e.g. ARFCN, NR-ARFCN etc), a frequency band indicator, a cell identifier (e.g. PCI, CGI, serving cell index etc) of a serving cell on the indicated carrier frequency etc.
Transmission point (TRP) information
   This information indicates the number of transmission points used by the NW node to transmit the data channels. For example, at the configuration, the NW code configures UE only need to receive signal from one TRP or UE need to receive signals from two TRPs.

The UE may receive the channel configuration setup above per frequency band and/or per TRP.

At the data channel configuration setup, the UE may also receive the NAI elements from the NW node.

At operation S124, the UE may determine or select a receiver algorithm to receive the configured data channel, according to the UE's receiver capability, the received NAI elements from the NW node, and one or more conditions. The followings are examples how to determine the receiver algorithm.
UE selects the legacy IRC-type receiver algorithm e.g., MMSE-IRC receiver algorithm e.g., when
   NW node does not provide any NAI elements, or
   NW node provides the NAI having only the information of existence of co-scheduled UE(s). In this case the UE assumes that the data channel may be interfered by other UE(s), but UE cannot use advanced MU-MIMO receiver algorithm because of lack of DMRS information for co-scheduled UEs.
UE selects the E-MMSE-IRC receiver algorithm e.g., when the NW node provides the NAI having information of existence of co-scheduled UE(s) and their DMRS information.
   UE may select (fallback to) the MMSE-IRC receiver algorithm, if at least one of the following preconfigured conditions is met. The conditions are e.g., the baseband processor load is so high that UE cannot finish the channel decoding within the specified timeline. Another condition is the measured channel BLER is below the threshold. Yet another condition is the measured channel condition (CQI) is below a threshold.
UE selects the R-ML receiver algorithm e.g., when the NW node provides the NAI having information of existence of co-scheduled UE(s), their DMRS information and modulation information.
   UE may select (fallback to) the E-MMSE-IRC or MMSE-IRC receiver algorithm, if at least one of the following preconfigured conditions is met. The conditions are e.g., the baseband processor load is so high that UE cannot finish the channel decoding within the specified timeline. Another condition is the measured channel BLER is below the threshold. Yet another condition is the measured channel condition (CQI) is below a threshold. Even another condition is the co-scheduled UE may use lower modulation orders such as QPSK/16QAM.

At operation S126, the NW node schedules the data to the configured UE(s), and at operation S128, the NW node transmits data to the UE and the co-scheduled UE(s). Here it may apply SU-MIMO or MU-MIMO, according to certain conditions. Examples of the conditions and applied transmission schemes are as follows:
Example 1: When the NW node only needs to schedule one UE (e.g., UE1), or the NW node does not have the MU-MIMO transmission functionality, it applies SU-MIMO.
Example 2: When the NW node transmits the data to one or more UEs, the NW node applies SU-MIMO single or multi-stream transmission to the UE(s) that have no advanced MU-MIMO receiver algorithm capabilities.
Example 3: When the NW node transmits the data to one or more UEs, the NW node applies MU-MIMO to the UEs that have the advanced MU-MIMO receiver algorithm capabilities. When scheduling the data, e.g., the NW node may co-schedule the UEs which have the same MU-MIMO receiver algorithm capabilities.

As shown in FIG. 11, the target UE and the co-scheduled UE may have the same MU-MIMO receiver algorithm capabilities, and thus the NW node may co-schedule the UEs and transmit data to them simultaneously at operation S128.

Accordingly, at operations S130 and S132, the target UE and the co-scheduled UE may receive the data or configured channels (e.g., PDSCH, PDCCH) according to the selected receiver algorithm. During receiving the data channels, the UE may continuously measure the conditions such as the baseband processor load, scheduled channel bandwidth, channel decoded results (BLER), and channel condition (CQI). According to the measurement results, the UE may re-select the receiver algorithm as in operation S124 described above.

So far, embodiments of the present disclosure have been described to provide the methods or operations in the UE and the network node. The UE supporting multiple variants of an MU-MIMO receiver capability may determine a suitable MU-MIMO receiver configuration based on its receiver capability and one or more conditions, and by using the UAI, recommends to the network node which MU-MIMO receiver type that the UE can apply currently. On the other hand, the network node may determine the NAI based on the received UAI and provide the NAI to the UE, so as to assist the UE to apply the MU-MIMO receiver type for receiving signals (e.g. PDCH). The embodiments of the present disclosure can provide advantages, for example, with the reported UE receiver capabilities, the NW node can know which UE(s) are capable of advanced MU-MIMO receiver algorithms, and the NW node can apply MU-MIMO to the UE(s) capable of advanced MU-MIMO receiver algorithms, which will increase the total network capacity. Further, with the UE reporting the UAI to the NW node, the NW node can know what NAI should be provided for the UE. Also, the NW node can control the amount of NAI element transmission according to the received UAI and certain conditions, e.g., its transmitter capability or traffic load. This can minimize the NAI signalling overhead. Still further, by receiving the NAI from the NW node, the UE can know whether the NW node applies MU-MIMO or not, that is, the UE can know whether received PDSCH symbols are interfered by co-scheduled UE or not. In addition, the UE may know existence of co-scheduled UE(s), the DMRS port(s) used by co-scheduled UE(s) and/or their DMRS/modulation information. Then, based on the knowledge, the UE can choose the proper receiver algorithm for MU-MIMO scenario. Further, the UE may choose the proper receiver algorithm considering one or more certain conditions, for example, antenna correlation, algorithm complexity, power consumption, baseband processor load, etc.

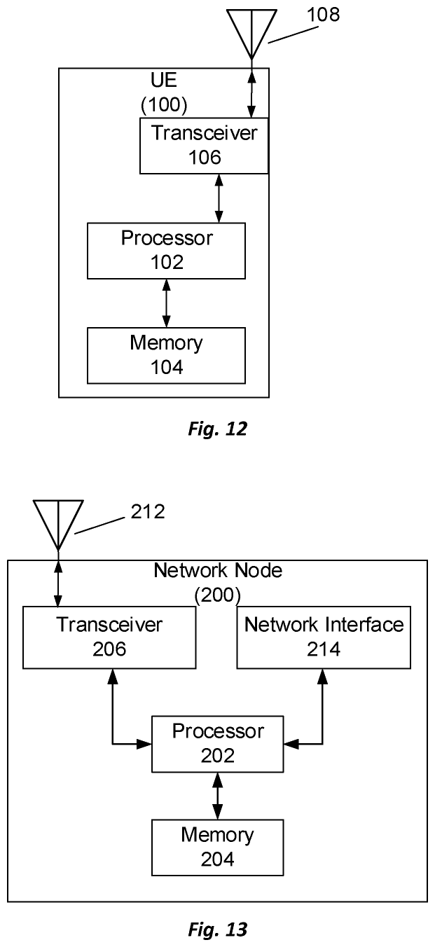

FIG. 12 is a schematic block diagram of a UE according to some embodiments of the present disclosure. It may be used as any of the UEs in FIG. 4. As illustrated, the UE 100 includes one or more processors 102 (e.g., CPUs, ASICs, FPGAs, and/or the like), memory 104, and one or more transceivers 106 each including one or more transmitters and one or more receivers coupled to one or more antennas 108. The transceiver(s) 106 includes radio-front end circuitry connected to the antenna(s) 112 that is configured to condition signals communicated between the antenna(s) 108 and the processor(s) 102, as will be appreciated by on of ordinary skill in the art. The processors 102 are also referred to herein as processing circuitry. The transceivers 106 are also referred to herein as radio circuitry. In some embodiments, the functionality of the UE 100 described herein may be fully or partially implemented in software that is, e.g., stored in the memory 104 and executed by the processor(s) 102. Note that the UE 100 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the UE 100 and/or allowing output of information from the UE 100), a power supply (e.g., a battery and associated power circuitry), etc.

In some embodiments, a computer program is provided to include instructions which, when executed by at least one processor, causes the at least one processor to carry out the functionality of the UE 100 according to any of the embodiments described herein, for example, one or more of the steps included in a method shown in FIGS. 9 and 11 described above. In some embodiments, a carrier comprising the aforementioned computer program product is provided. The carrier is one of an electronic signal, an optical signal, a radio signal, or a computer readable storage medium (e.g., a non-transitory computer readable medium such as memory).

In some embodiments, the UE 100 may include one or more modules, each of which is implemented in software. The module(s) provide the functionality of the UE 100 according to any of the embodiments described herein.

FIG. 13 is a schematic block diagram of a network node according to some embodiments of the present disclosure. As illustrated, the network node 200 includes one or more processors 202 (e.g., CPUs, ASICs, FPGAs, and/or the like), memory 204, one or more transceivers 206 each including one or more transmitters and one or more receivers coupled to one or more antennas 212, and network interface 214. The transceiver(s) 206 includes radio-front end circuitry connected to the antenna(s) 212 that is configured to condition signals communicated between the antenna(s) 212 and the processor(s) 202, as will be appreciated by on of ordinary skill in the art. The processors 202 are also referred to herein as processing circuitry. The transceivers 206 are also referred to herein as radio circuitry. The network interface 214 may be configured to provide communications with other network nodes and/or core network. In some embodiments, the functionality of the network node 200 described herein may be fully or partially implemented in software that is, e.g., stored in the memory 204 and executed by the processor(s) 202. Note that the network node 200 may include additional components not illustrated in FIG. 13, such as a power supply and associated power circuitry, etc.

In some embodiments, a computer program is provided to include instructions which, when executed by at least one processor, causes the at least one processor to carry out the functionality of the network node 200 according to any of the embodiments described herein, for example, one or more of the steps included in methods shown in FIGS. 10 and 11 described above. In some embodiments, a carrier comprising the aforementioned computer program product is provided. The carrier is one of an electronic signal, an optical signal, a radio signal, or a computer readable storage medium (e.g., a non-transitory computer readable medium such as memory).

In some embodiments, the network node 200 includes one or more modules, each of which is implemented in software. The module(s) provide the functionality of the network node 200 according to any of the embodiments described herein.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

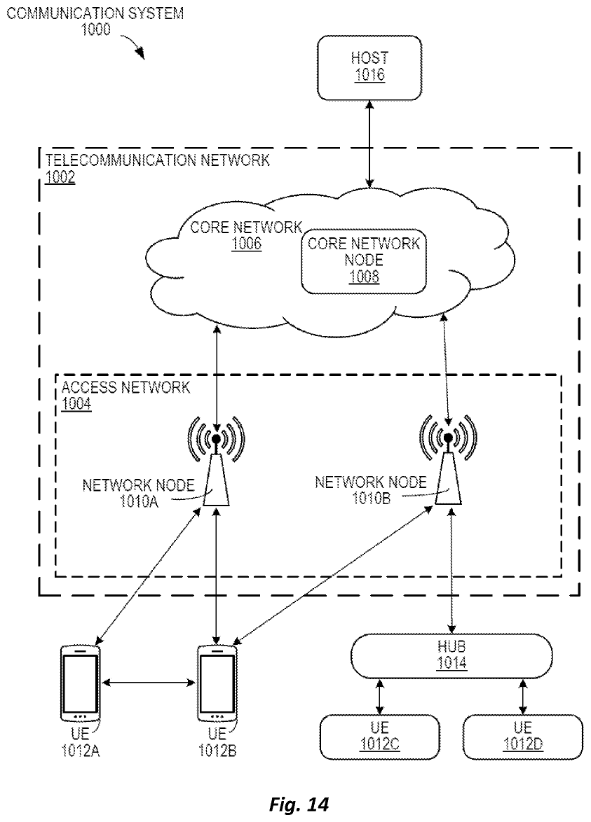

FIG. 14 shows an example of a communication system 1000 in accordance with some embodiments. The concept of the present disclosure may be applied in the communication system 1000. In this example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF). The SMF and AMF as well as methods in them according to various embodiments of the present disclosure may be implemented in the core network nodes.

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In various embodiments, core network node 1008 can implement network function (NF) of communication system or network 900. In other words, the NF may be located in the core network 1006 or coupled to the core network 1006. Such a NF can be configured to perform operations corresponding to exemplary methods described above.

As a whole, the communication system 1000 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-RAT or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

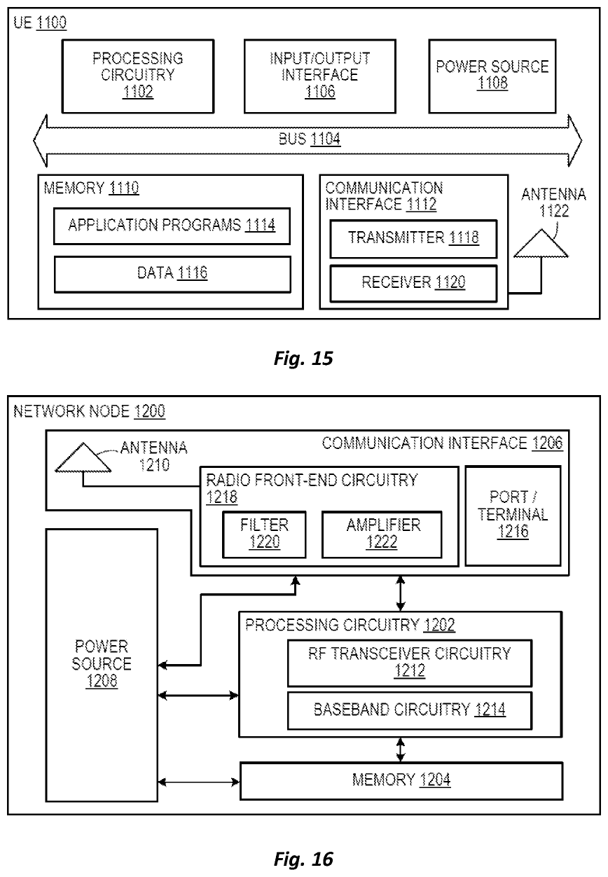

FIG. 15 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1200 in accordance with some embodiments. The RAN node of the present disclosure may be implemented with the network node 1200. The network node may refer to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 16 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

In various embodiments, network node 1200 can be configured to perform operations performed by network nodes, network functions (NFs), and application functions (AFs) in exemplary methods or procedures described above.

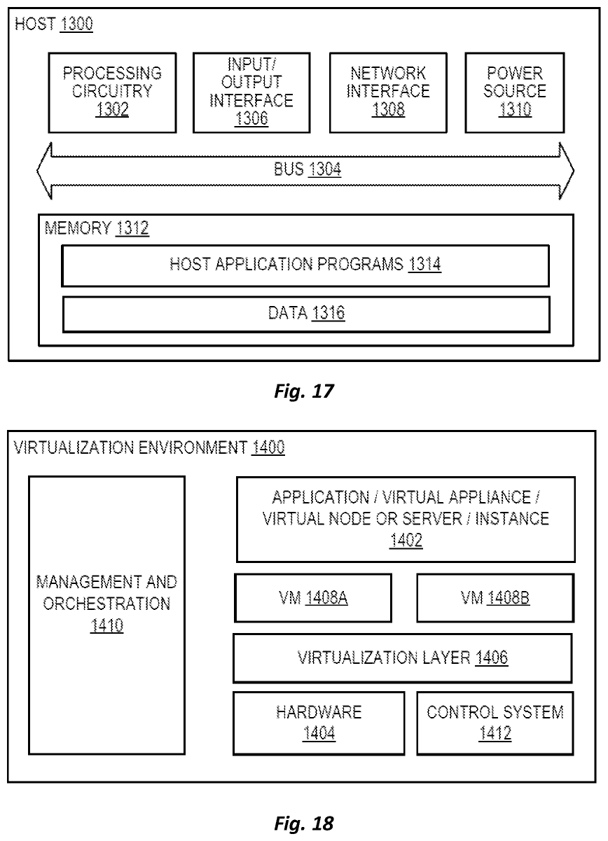

FIG. 17 is a block diagram of a host 1300, which may be an embodiment of the host 1016 of FIG. 14, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

In various embodiments, virtualization environment 1400 can be configured to host various network functions (NFs) and application functions (AFs) described above. In other words, these NFs and AFs can be implemented in respective virtual nodes 1402 based on underlying hardware 1404. These respective virtual nodes 1402 can be configured to perform various exemplary methods or procedures described above.

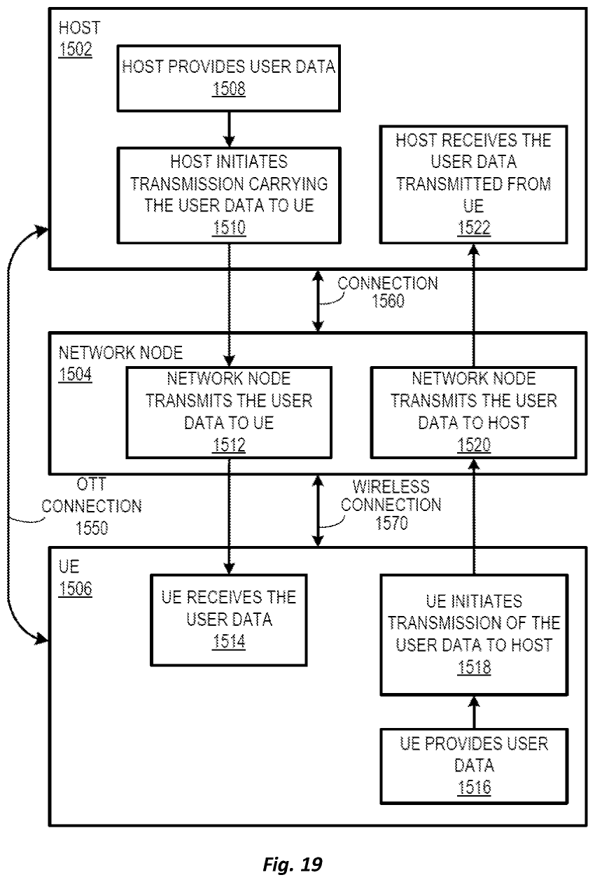

FIG. 19 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 14 and/or UE 1100 of FIG. 15), network node (such as network node 1010a of FIG. 14 and/or network node 1200 of FIG. 16), and host (such as host 1016 of FIG. 14 and/or host 1300 of FIG. 17) discussed in the preceding paragraphs will now be described with reference to FIG. 19.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 14) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506.

The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, embodiments described herein can provide a new service operation by which an NEF can request a UDM to remove authorization related to a service-specific parameter provisioning request, e.g., before a validity time for the authorization expires. Upon receiving such a request, the UDM can release and stop monitoring for updates pertaining to the resources related to the authorization This avoids waste of UDM resources (e.g., signaling, processing, storage, etc.) and facilitates more efficient operation of the 5GC. These increased efficiencies improve the delivery of OTT services via the 5GC, thereby increasing the value of such OTT services to both end users and service providers.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

| Abbreviation | Explanation |
|---|---|
| ACK | Acknowledgement |
| AWGN | Additive White Gaussian Noise |
| CQI | Channel Quality Indicator |
| CSI | Channel State Information |
| CSI-RS | Channel State Information Reference Signal |
| CC | Component Carrier |
| DCI | Downlink Control Information |
| DMRS | Demodulation Reference Signal |
| E-MMSE-IRC | Enhanced Minimum Mean Square Error receiver with |
| | Interference Rejection Combining |
| FDD | Frequency Division Duplex |
| HARQ | Hybrid Automatic Repeat Request |
| MIMO | Multiple-Input Multiple-Output |
| MMSE-IRC | Minimum Mean Square Error receiver with Interference |
| | Rejection Combining |
| MU-MIMO | Multi-User Multiple-Input Multiple-Output |
| NACK | Non-acknowledgement |
| NAI | Network Assistance Information |
| NR | New Radio |
| NW | Network |
| OFDM | Orthogonal Frequency Division Multiplexing |
| PDCCH | Physical Downlink Control Channel |
| PDSCH | Physical Downlink Shared Channel |
| PMI | Precoding Matrix Indicator |
| QAM | Quadrature Amplitude Modulation |
| QPSK | Quadrature Phase Shift Keying |
| R-ML | Reduced complexity Maximum Likelihood |
| RRC | Radio Resource Control |
| RSRP | Reference Signal Receive Power |
| SINR | Signal to Interference plus Noise Ratio |
| SNR | Signal to Noise Ratio |
| SU-MIMO | Single-User Multiple-Input Multiple-Output |
| TDD | Time Division Duplex |
| UAI | UE Assistance Information |
| UE | User Equipment |

1.-29. (canceled)

30. A method in a User Equipment (UE), the method comprising:
transmitting, to a network node connected to the UE, UE receiver capability information indicating a Multiuser-Multiple Input Multiple Output (MU-MIMO) receiver capability supported by the UE, wherein the MU-MIMO receiver capability includes at least one advanced MU-MIMO receiver capability;
reporting, to the network node, UE Assistance Information (UAI) indicating the UE's preference on an MU-MIMO receiver capability;
receiving, from the network node, Network Assistance Information (NAI) that is determined by the network node based on the UE receiver capability information and the reported UAI; and
receiving data from the network node by using an MU-MIMO receiver capability based on the received NAI.

31. The method of claim 30, wherein the at least one advanced MU-MIMO receiver capability includes one or more of Enhanced Minimum Mean Square Error receiver with Interference Rejection Combining (E-MMSE-IRC) receiver capability, and Reduced complexity Maximum Likelihood (R-ML) receiver capability.

32. The method of claim 30, wherein the UE receiver capability information further indicates one or more of:
a maximum number of MIMO layers the UE can receive,
a maximum modulation order supported by the UE, and
a number of receive antenna panels the UE can receive simultaneously.

33. The method of claim 30, wherein:
the UE receiver capability information is provided by the UE separately for each Component Carrier (CC) or for a group of CCs, or for all CCs supported by the UE, and/or
the UE receiver capability information is provided by UE separately for each frequency band, or for a group of frequency bands, or for all frequency bands.

34. The method of claim 30, wherein the UAI includes one or more elements representing information of one or more co-scheduled UEs, which are connected to the network node and to which the network node transmits data simultaneously with the UE by using MU-MIMO transmission.

35. The method of claim 34, wherein the information of one or more co-scheduled UEs includes one or more of:
existence of the one or more co-scheduled UEs,
Demodulation Reference Signal (DMRS) port information used by the one or more co-scheduled UEs including port numbers and DMRS sequence information, and
modulation order used by the one or more co-scheduled UEs.

36. The method of claim 30, wherein the UAI depends on one or more conditions related to the UE's operation, the one or more conditions related to the UE's operation include one or more of:
UE receive antenna correlation,
UE internal condition/resource,
UE reception signal quality,
UE coverage status/level in a cell,
UE mobility state, and
UE power saving operational mode.

37. The method of claim 34, wherein the UAI indicates only the existence of the one or more co-scheduled UEs if:
the UE does not support any advanced MU-MIMO receiver capability;
the UE cannot finish data channel decoding within a processing time when the UE uses an advanced MU-MIMO receiver capability;
the UE supports Enhanced Minimum Mean Square Error receiver with Interference Rejection Combining (E-MMSE-IRC) receiver capability but the UE's receive antenna correlation is low for a configured frequency band;
the UE has a poor reception signal quality;
the UE has an enhanced coverage level in a cell;
the UE has a high mobility state;
the UE has an internal condition/resource that does not allow use of an advanced MU-MIMO receiver capability; or
the UE is not operating in a power saving operational mode.

38. The method of claim 34, wherein the UAI indicates both of the existence of the one or more co-scheduled UEs and the DMRS port information used by the one or more co-scheduled UEs, or all of the existence of the one or more co-scheduled UEs, the DMRS port information used by the one or more co-scheduled UEs and the modulation order used by the one or more co-scheduled UEs, if:
the UE can finish data channel decoding within a processing time when the UE uses an advanced MU-MIMO receiver capability;
the UE has a good reception signal quality;
the UE has a normal coverage level in a cell;
the UE has a low/normal mobility state;
the UE has an internal condition/resource that allows use of an advanced MU-MIMO receiver capability; or
the UE is operating in a power saving operational mode.

39. The method of claim 34, wherein:
the UAI indicates both of the existence of the one or more co-scheduled UEs and the DMRS port information used by the one or more co-scheduled UEs, if the UE supports Enhanced Minimum Mean Square Error receiver with Interference Rejection Combining (E-MMSE-IRC) receiver capability but the UE's receive antenna correlation is medium or high for a configured frequency band; and
the UAI indicates all of the existence of the one or more co-scheduled UEs, the DMRS port information used by the one or more co-scheduled UEs and the modulation order used by the one or more co-scheduled UEs, if the UE supports R-ML receiver capability but the UE's receive antenna correlation is medium or high for a configured frequency band.

40. The method of claim 30, wherein the NAI indicates one or more of:
existence of one or more co-scheduled UEs,
DMRS port information used by the one or more co-scheduled UEs including port numbers and DMRS sequence information, and
modulation order used by the one or more co-scheduled UEs.

41. The method of claim 40, wherein in the NAI, the modulation order includes the maximum modulation order indicated as common for the one or more co-scheduled UEs or indicated per DMRS port.

42. The method of claim 30, wherein the MU-MIMO receiver capability to be used for data reception is further based on one or more conditions including one or more of:
the UE's baseband processor load,
the UE's scheduled channel bandwidth,
the UE's measured channel decoding error rate, and
the UE's measured channel condition.

43. The method of claim 42, further comprising, during receiving data from the network node, monitoring the one or more conditions and determining the MU-MIMO receiver capability to be used for data reception based on the monitored conditions.

44. A User Equipment (UE), comprising:
a processor; and
a memory storing instructions that, when executed by the processor, cause the UE to:
transmit, to a network node connected to the UE, UE receiver capability information indicating a Multiuser-Multiple Input Multiple Output (MU-MIMO) receiver capability supported by the UE, wherein the MU-MIMO receiver capability includes at least one advanced MU-MIMO receiver capability;
report, to the network node, UE Assistance Information (UAI) indicating the UE's preference on an MU-MIMO receiver capability;
receive, from the network node, Network Assistance Information (NAI) that is determined by the network node based on the UE receiver capability information and the reported UAI; and
receive data from the network node by using an MU-MIMO receiver capability based on the received NAI.

45. The UE of claim 44, wherein the at least one advanced MU-MIMO receiver capability includes one or more of Enhanced Minimum Mean Square Error receiver with Interference Rejection Combining (E-MMSE-IRC) receiver capability, and Reduced complexity Maximum Likelihood (R-ML) receiver capability.

46. The UE of claim 44, wherein the UE receiver capability information further indicates one or more of:
a maximum number of MIMO layers the UE can receive,
a maximum modulation order supported by the UE, and
a number of receive antenna panels the UE can receive simultaneously.

47. The UE of claim 44, wherein the UAI includes one or more elements representing information of one or more co-scheduled UEs, which are connected to the network node and to which the network node transmits data simultaneously with the UE by using MU-MIMO transmission.

48. A method in a network node, the method comprising:
receiving, from a User Equipment (UE) connected to the network node, UE receiver capability information indicating a Multiuser-Multiple Input Multiple Output (MU-MIMO) receiver capability supported by the UE, wherein the MU-MIMO receiver capability includes at least one advanced MU-MIMO receiver capability;
receiving, from the UE, a report of UE Assistance Information (UAI) indicating the UE's preference on an MU-MIMO receiver capability; and
providing, to the UE, Network Assistance Information (NAI), wherein the NAI is based on a MIMO transmission scheme to be used, the UE receiver capability information and the UAI.

49. A network node, comprising:
a processor; and
a memory storing instructions that, when executed by the processor, cause the network node to:
receive, from a User Equipment (UE) connected to the network node, UE receiver capability information indicating a Multiuser-Multiple Input Multiple Output (MU-MIMO) receiver capability supported by the UE, wherein the MU-MIMO receiver capability includes at least one advanced MU-MIMO receiver capability;
receive, from the UE, a report of UE Assistance Information (UAI) indicating the UE's preference on an MU-MIMO receiver capability; and
provide, to the UE, Network Assistance Information (NAI), wherein the NAI is based on a MIMO transmission scheme to be used, the UE receiver capability information and the UAI.
